(19) United States
(12) Patent Application Publication
(10) Pub. No.: US 2013/0332250 A1
(43) Pub. Date: Dec. 12, 2013

(54) SYSTEMS AND METHODS FOR PROVIDING CONDITIONAL GROUP PURCHASE OFFERS FOR MEDIA CONTENT

(71) Applicants: Samir B. Armaly, La Canada Flintridge, CA (US); Kim R. Dykeman, San Francisco, CA (US)

(72) Inventors: Samir B. Armaly, La Canada Flintridge, CA (US); Kim R. Dykeman, San Francisco, CA (US)

(73) Assignee: UNITED VIDEO PROPERTIES, INC., Santa Clara, CA (US)

(21) Appl. No.: 13/490,224

(22) Filed: Jun. 6, 2012

(51) Int. Cl. G06Q 30/02

(52) U.S. Cl. 705/14.23

(57) ABSTRACT

Systems and methods for providing conditional group purchase offers are provided. A conditional offer for an on-demand media asset, such as a movie, television episode, or streaming video is transmitted to a plurality of users. The conditional offer is conditioned on a minimum quantity of purchases being performed within a specified time period. The purchase requests are received at a processing device, which determines whether the amount of purchase requests exceeds the minimum quantity of purchases within the specified time period, and performs a corresponding action based on the amount of purchase requests.

### BACKGROUND OF THE INVENTION

Modern day consumers are confronted with numerous entertainment options and a large amount of available media content. Thousands of videos, songs, and articles are available to users through the Internet, television, and other gateways to media content. In such an environment, where consumption options are plentiful, social interactions play an important role in influencing media consumption and purchase choices.

Consumers have access to large amounts of low cost or free media content and continually seek to access media content as inexpensively as possible. However, traditional systems fail to provide a fast and convenient way for users to access at a low cost content that requires payment. Web-based services, such as Groupon, offer coupons or discounts for third-party goods and services based on a minimum number of purchases performed within a specified time period. However, these web-based services fail to provide a mechanism for users to purchase on-demand media content at lower cost.

### SUMMARY OF THE INVENTION

Accordingly, systems and methods for providing conditional group purchase offers are provided. In certain embodiments, a processing device transmits a conditional group purchase offer for an on-demand media asset, such as a movie, television episode, or streaming video, to a plurality of users. The conditional offer is conditioned on a minimum quantity of purchases being performed within a specified time period. The purchase requests are received at the processing device, which determines whether the amount of purchase requests exceeds the minimum quantity of purchases within the specified time period, and performs a corresponding action based on the amount of purchase requests.

In certain embodiments, the processing device generates a conditional offer for an access privilege to the media asset to incentivize users to purchase the media asset and invite companion users to purchase the media asset. For example, the access privilege may be for access to the media asset at a discounted price, access to the media asset on a plurality of devices, access to the media asset for an extended time period, access to a high definition version of the media asset, and access to a second media asset. The processing device receives purchase requests and determines whether the minimum quantity of purchase requests has been received within the specified time period. For example, the processing device may generate an incremental counter, increase the counter with each purchase request, and compare the counter to the conditional minimum quantity. The processing device also determines whether the specified time limit has been exceeded. The processing device may access and modify a database stored locally or on a remote server. The database may store the media asset, counter, purchase requests, and offer specifications, including the conditional price, the minimum quantity of purchases required to receive the asset at the conditional price, the time period for the conditional offer, or a combination thereof.

In certain approaches, if the minimum quantity of purchase requests is received, the processing device delivers the media asset to the users who requested purchase. For example, the media asset may be transmitted via a communications network. In certain approaches, the processing device synchronizes access to the on-demand media asset at a plurality of user devices. The processing device additionally processes payment for the media asset, for example, by processing a charge to a user account, credit card, or other payment method. If the amount of purchase requests does not exceed the minimum quantity of purchases within the specified time period, the processing device terminates the conditional offer, does not process the purchase requests, and does not deliver the media asset. The processing device may transmit a notification to the users who requested purchase to inform them that the purchase will not be performed. In certain approaches, the processing device processes a payment for each of the plurality of requests to complete the purchase for the on-demand media asset at a standard price, in response to determining that the amount does not exceed the minimum quantity of purchases within the specified time period.

In some embodiments, systems and methods are provided for allowing a user to invite other potential users to participate in the conditional offer and request purchase of the media asset. In some embodiments, the conditional offer is further conditioned upon receiving identification of companion users from the first user. The first user provides identification of the companion users, for example, by accessing a contact list. The processing device receives identification of a plurality of companion users and transmits invitations to the companion users to participate in the conditional offer. In certain approaches, the processing device accesses a plurality of user profiles associated with a plurality of companion users, analyzes the plurality of user profiles, generates a list of companion users based on analyzing the user profiles, and transmits the list of companion users to a user device associated with a first user

The conditional group purchase offer may be generated by the processing device automatically or responsive to a request from the user. For example, the conditional offer may be generated automatically when a user device is turned on, at periodic intervals, or according to a predetermined schedule. In some implementations, the processing device generates a conditional offer in response to receiving a user request to watch on-demand content. In certain approaches, the processing device accesses a user profile associated with a first user, analyzes the user profile, and generates a conditional offer based on analyzing the user profile.

In certain embodiments, the processing device receives a user request to generate a user-defined conditional group purchase offer. The request may include an identification of a media asset, a requested conditional price, a requested minimum quantity of purchases required to receive the asset at the conditional price, a requested time period for purchasing the asset at the conditional price, or a combination thereof. The processing device analyzes the request to generate a conditional group offer and determines whether to provide the requested conditional group offer, for example, by determining a value factor, which may incorporate transmission costs, estimated probability of receiving the minimum quantity of purchase requests, recent sales, recent user purchases, availability of the media asset, license agreements, profit margins, and other factors.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user equipment device in accordance with some embodiments of the present disclosure;

FIG. 4 illustrates an example of a cross-platform interactive media system in accordance with some embodiments of the present disclosure;

FIG. 5 shows an illustrative display screen presenting a conditional group purchase offer for an on-demand media asset in accordance with some embodiments of the present disclosure;

FIG. 6 shows an illustrative display screen presenting a conditional invitation-based group offer for an on-demand media asset in accordance with some embodiments of the present disclosure;

FIG. 7 shows an illustrative display screen for inviting companion users to view an on-demand media asset in accordance with some embodiments of the present disclosure;

FIG. 8 shows an illustrative display screen for selecting a method of inviting a companion user in accordance with some embodiments of the present disclosure;

FIG. 9 shows an illustrative display screen for displaying an invitation for a conditional offer to a companion user in accordance with some embodiments of the present disclosure;

FIG. 10 shows an illustrative system for providing a conditional offer for a media asset and distributing the media asset in accordance with some embodiments of the present disclosure;

FIG. 11 illustrates a flow diagram for providing a conditional offer for an on-demand media asset in accordance with some embodiments of the present disclosure;

FIG. 12 shows an illustrative flow diagram for providing a conditional offer for an on-demand media asset in accordance with some embodiments of the present disclosure;

FIG. 13 shows an illustrative flow diagram for providing an offer conditioned on receiving identification of companion users in accordance with some embodiments of the present disclosure;

FIG. 14 illustrates a flow diagram for processing a conditional offer in accordance with some embodiments of the present disclosure;

FIG. 15 illustrates a flow diagram for providing a secondary offer in accordance with some embodiments of the present disclosure; and

FIG. 16 illustrates a user profile stored as a file in Extensible Markup Language (XML) in accordance with some embodiments of the present disclosure.

### DETAILED DESCRIPTION OF THE VARIOUS EMBODIMENTS

Systems and methods for providing conditional group purchase offers are provided herein. A conditional offer for an on-demand media asset, such as a movie, television episode, or streaming video, is transmitted to a plurality of users. The conditional offer is conditioned on a minimum quantity of purchases being performed within a specified time period. The purchase requests are received at a processing device, which determines whether the amount of purchase requests exceeds the minimum quantity of purchases within the specified time period, and performs a corresponding action based on the amount of purchase requests.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

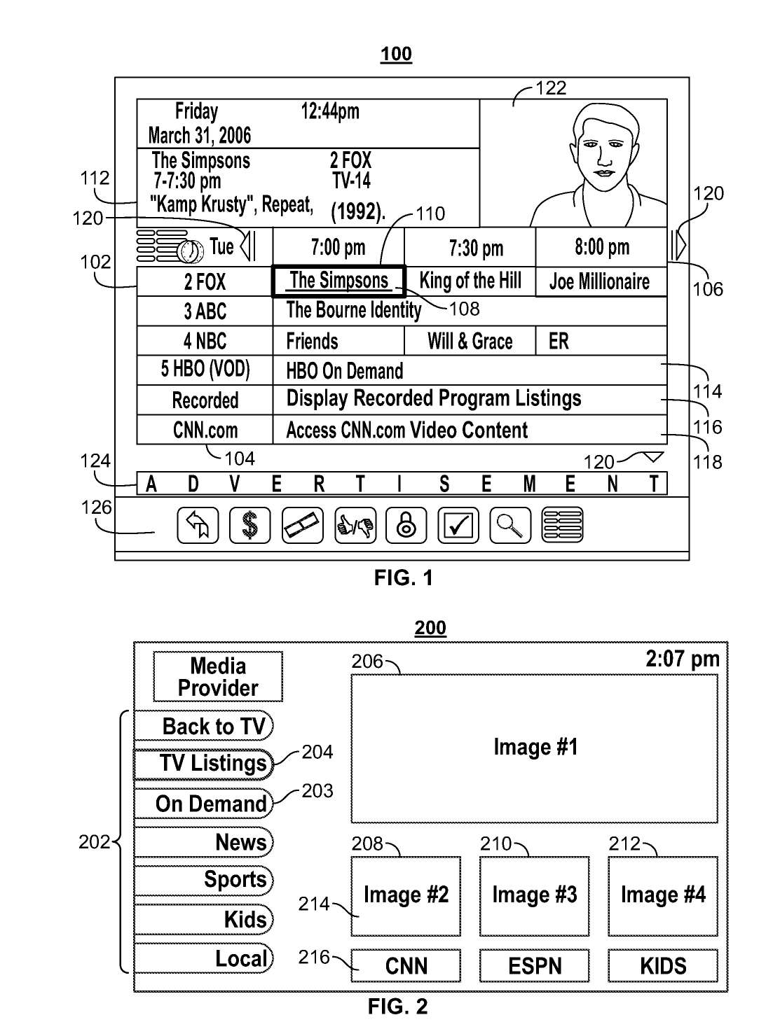

FIGS. 1-2 show illustrative display screens that may be used to provide media guidance data. The display screens shown in FIGS. 1-2 and 5-9 may be implemented on any suitable user equipment device or platform. While the displays of FIGS. 1-2 and 5-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

Additionally or alternatively to providing access to linear programming (e.g., content that is scheduled to be transmitted to a plurality of user equipment devices at a predetermined time and is provided according to a schedule), the media guidance application may provide access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g., FTP). In some implementations, the media guidance application may provide access to only linear programming or only non-linear programming (e.g., only on-demand media assets or only recorded media assets).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be for on-demand content or for a special offer to purchase on-demand content. For example, advertisement 124 may be for a conditional group purchase offer for a media asset, such as an on-demand asset. For example, the media asset is offered at a reduced priced conditioned upon receiving a predetermined minimum quantity of purchase requests within a specified time period. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, receiving a notification, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, options to connect with social network applications, options to access a media asset with a group purchase conditional offer, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, “buddy lists” or “friend lists,” e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application, such as purchases. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

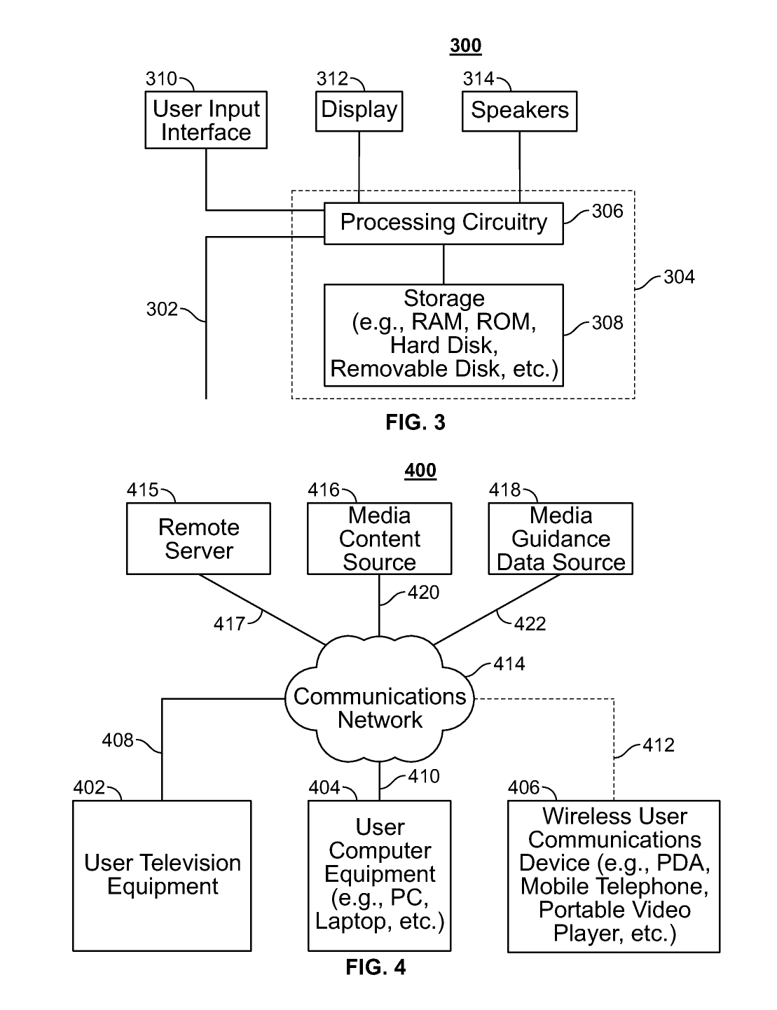

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11×, etc.), or other short-range communication via wired or wireless paths. BLUETOOTH is a certification mark owned by Bluetooth SIG, INC. The user equipment devices may also communicate with each other directly through an indirect path via communications network 414.

System 400 includes remote server 415, content source 416, and media guidance data source 418 coupled to communications network 414 via communication paths 417, 420, and 422, respectively. Paths 417, 420, and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and a server application resides on a remote server. For example, media guidance applications may be implemented partially as a client application on control circuitry 304 of user equipment device 300 and partially on a remote server as a server application (e.g., media guidance data source 418) running on control circuitry of the remote server 415. When executed by control circuitry of the remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having a content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, a remote server 415 coupled to communications network 414 may generate a conditional group purchase offer for a media asset, such as an on-demand media asset or any other media asset, as described herein. For example, remote server 415 may generate a conditional group purchase offer for access to a media asset at a reduced price (e.g., compared to a standard price), but the remote server 415 only provides access to the asset if a predetermined minimum quantity of purchase requests are made for the media asset within a specified time period, thereby incentivizing users to invite or encourage additional users to request purchase of the asset. In certain approaches, the purchase requests are received from users who are identified and/or invited by a first user or group of users. Additionally or alternatively, the user requests may be received from users who were not identified and/or invited by another user. For example, remote server 415 may transmit the conditional offer to a plurality of users who have requested to receive conditional offers for group purchases of media assets. In certain approaches, users receive the conditional group purchase responsive to requesting access to the conditional group purchase offer, for example, by accessing on-demand option 114 or advertisement 124 of screen 100, or on-demand option 203 of screen 100.

Additionally or alternatively to a reduced price, the conditional offer may include other incentives, such as enhanced access rights or privileges to the media asset. For example, the remote server 415 may provide access to the media asset on multiple devices (e.g., second screen devices), extend the access period to the media asset (e.g., standard access may be for 1 day and extended access may be for 1 week), provide a high definition version of a media asset instead of a standard definition version, provide credits for receiving additional media assets, provide additional or exclusive media assets (e.g., “bonus content”), or combinations thereof. In certain approaches, the conditional offer may include combinations of incentives, for example, a conditional offer for a reduced price media asset with an extended access period, or any other combination. Remote server 415 may also transmit the conditional offer to a plurality of users, process user purchases, and distribute the media asset.

In certain embodiments, with a standard purchase of a media asset, remote server 415 may enable access of a media asset only on a single user device. Remote server 415 may generate a conditional group purchase offer for access to a media asset, whereby if a predetermined minimum quantity of purchase requests are received for the media asset within a specified time period, a user may access the media asset on a second device or any number of devices. For example, a user want access the media asset at different locations (e.g., home and office), or with different user devices (e.g., computer, television, and mobile device).

In certain embodiments, with a standard purchase of a media asset, remote server 415 may enable access to the media asset for a limited time period, such as 24 hours. Remote server 415 may generate a conditional group purchase offer for access to a media asset, whereby if a predetermined minimum quantity of purchase requests are received for the media asset within a specified time period, remote server 415 provides access for an extended period of time, such as 1 week.

In certain embodiments, with a standard purchase of a media asset, remote server 415 may provide the asset in a standard definition version and charge extra for a high definition version. Remote server 415 may generate a conditional group purchase offer for access to a media asset, whereby if a predetermined minimum quantity of purchase requests are received for the media asset within a specified time period, remote server 415 provides access to a high definition version of the media asset.

In certain embodiments, the conditional group offer may include credits for receiving additional media assets, or provide additional or exclusive media assets (e.g., “bonus content”). For example, remote server 415 may generate a conditional group purchase offer for access to a media asset, whereby if a predetermined minimum quantity of purchase requests are received for the media asset within a specified time period, remote server 415 provides credits, whereby the user may use the credits to request access to one or more additional media assets. In an alternative example, remote server 415 may generate a conditional group purchase offer for access to a media asset, whereby if a predetermined minimum quantity of purchase requests are received for the media asset within a specified time period, remote server 415 enables access to additional content. For example, if a movie is part of a series, remote server 415 may provide access to other movies in the series. Additionally or alternatively, remote server may provide access to “bonus content” related to the media asset, such as “behind-the-scenes” videos, commentary, or other content.

Remote server 415 may include the same or similar circuitry or components as control circuitry 304. Remote server 415 may also include additional components, servers, modules, data stores, and devices for providing a conditional group purchase offer, as will be described in further detail below in connection with FIG. 10.

In some embodiments, remote server 415 generates a conditional group purchase offer for an on-demand media asset responsive to receiving a request to view an on-demand media asset. For example, remote server 415 may receive a request to access on-demand option 114 or advertisement 124 of screen 100, or on-demand option 203 of screen 100. Remote server 415 generates specifications for the conditional offer, including, but not limited to, the media asset offered, the conditional price, the minimum quantity of purchases required to receive the asset at the conditional price, the time period for the conditional offer, or a combination thereof. In certain embodiments, remote server 415 stores the conditional offer specifications in a database, for example, in storage 308 of FIG. 3.

Remote server 415 transmits the conditional offer via communications network 414 to a user device, for example, user device 402, 404, or 406. A user device may also include a processing device, such as control circuitry 304. The processing device of the user device presents the received conditional offer to a user. In some approaches, the conditional offer is presented on a display, such as display 312. Additionally or alternatively, the user device may provide audio content to the user, for example, with speakers 314, to present the conditional offer.

In certain embodiments, remote server 415 receives a user request to generate a user-defined conditional group purchase offer. The request may include an identification of a media asset, a requested conditional price, a requested minimum quantity of purchases required to receive the asset at the conditional price, a requested time period for purchasing the asset at the conditional price, or a combination thereof. For example, control circuitry 304 of the user equipment may receive a conditional offer request from user input interface 310, and transmit the request to the remote server 415 via communications network 414.

Remote server 415 analyzes the request to generate a conditional group offer and determines a value factor. The value factor is an assessment of the request, which may incorporate transmission costs, estimated probability of receiving the minimum quantity of purchase requests, recent sales, recent user purchases, availability of the media asset, license agreements, profit margins, and other factors. If the value factor exceeds a predetermined threshold, remote server 415 accepts the user request and provides the conditional group offer.

In certain approaches, remote server 415 receives purchase requests for the media asset at the conditional price. For example, the control circuitry 304 of the user equipment may receive a purchase request from user input interface 310, and transmit the purchase request to the remote server 415 via communications network 414. The remote server 415 determines whether the minimum quantity of purchase requests has been received. For example, the control circuitry 304 of the remote server 415 may generate an incremental counter, increase the counter with each purchase request, and compare the counter to the conditional minimum quantity.

Remote server 415 may also provide options for transmitting invitations to companion users to request purchase of the media asset at the conditional price. In certain embodiments, remote server 415 receives identification of companion users. The identification of companion users may also include a preferred transmission method, such as email, text message, instant message, other electronic communication means. Remote server 415 retrieves the conditional offer specifications, generates an invitation, and transmits the conditional offer through communications network 414 to the devices of companion users.

In certain approaches, the remote server 415 includes a database to store the media asset, counter, purchase requests, and offer specifications, including the conditional price, the minimum quantity of purchases required to receive the asset at the conditional price, the time period for the conditional offer, or a combination thereof. The database of remote server 415 may be stored, for example, in storage 308 of FIG. 3. The database may be modified and accessed by the control circuitry (e.g., control circuitry 304) of the remote server 415.

In certain approaches, the remote server 415 processes payment for the media asset. For example, remote server 415 may transmit payment data to a payment account through communications network 515. When the conditional minimum quantity is met or exceeded, remote server 415 provides access to the media asset to user devices corresponding to users who requested purchase of the media asset. For example, remote server 415 may transmit the media asset to user devices 402, 404, or 406 via communications network 414.

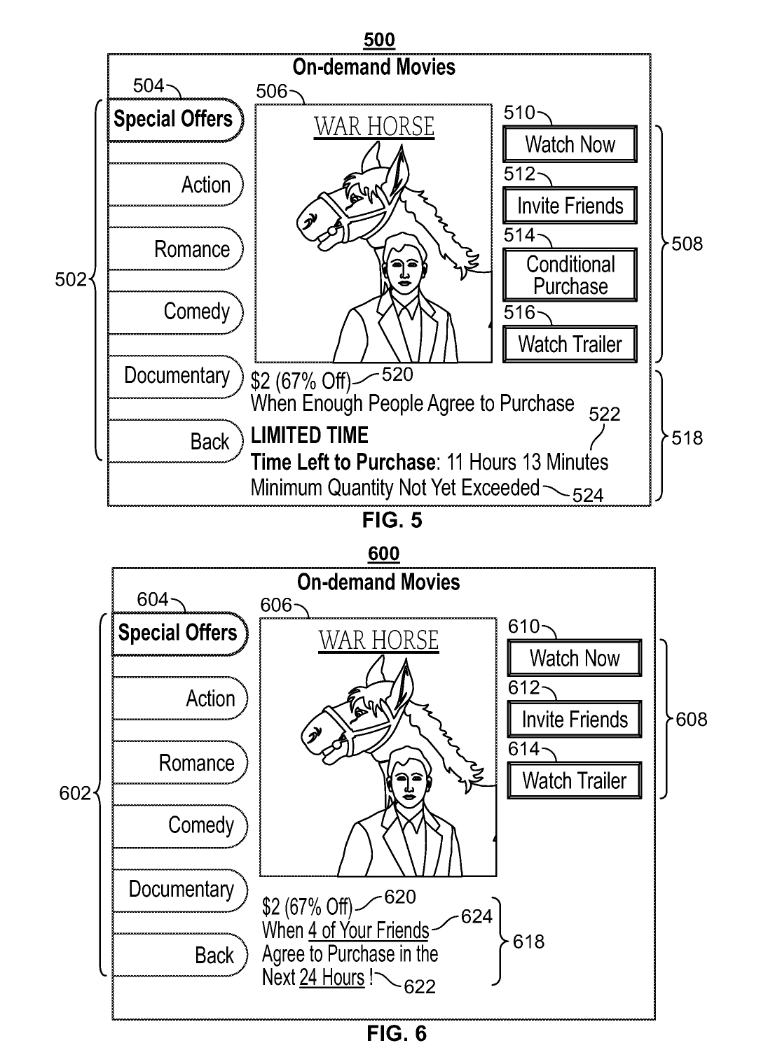

FIG. 5 shows an illustrative display screen 500 presenting a conditional group purchase offer for an on-demand media asset. The media asset is offered at a reduced price, but the control circuitry (e.g., control circuitry 304 of remote server 415) only provides access to the asset at the reduced price if a predetermined minimum quantity of purchase requests are received for the media asset within a specified time period, thereby incentivizing users to invite or encourage additional users to request purchase of the asset. Additionally or alternatively to a reduced price, the conditional offer may include other incentives, such as enhanced access rights or privileges to the media asset. For example, the control circuitry 304 of remote server 415 may provide access to the media asset on multiple devices (e.g., second screen devices), extend the access period to the media asset (e.g., standard access may be for 1 day and extended access may be for 1 week), provide a high definition version of a media asset instead of a standard definition version, provide credits for receiving additional media assets, or provide additional or exclusive media assets (e.g., “bonus content”). In certain approaches, control circuitry 304 initially transmits the conditional offer simultaneously to a plurality of user devices. For example, control circuitry 304 may access a database of user profiles and transmit the conditional offer specifications to user devices via communications network 414.

The conditional group purchase offer presented to the user by display screen 500 may be generated by control circuitry 304 of a user device or remote server automatically or responsive to a request from the user. For example, the conditional offer may be generated by control circuitry 304 automatically when a user device (e.g., television equipment 402, computer equipment 404, or wireless user communications device 406) is turned on, at periodic intervals (e.g., daily), or according to a predetermined schedule (e.g., on the release date of a movie). In some implementations, control circuitry 304 of a user device may generate screen 500 in response to receiving a user request to watch on-demand content by making a selection on screen 100 or 200. For example, control circuitry 304 of a remote server or user device may receive a request to access on-demand option 114 or advertisement 124 of screen 100, or on-demand option 203 of screen 200. In certain embodiments, control circuitry 304 of a remote server or user device generates the conditional offer in response to receiving a user selection of the “Special Offers” listing 504 on display screen 500. In certain approaches, control circuitry 304 generates screen 500 to a plurality of user devices associated with a plurality of users. For example, control circuitry 304 may transmit the conditional offer to a plurality of user devices associated with users who have requested to receive conditional offers for group purchases of media assets.

The conditional offer may also be generated responsive to a selection of other listing options accessible by the user. In one example, the conditional offer is presented on screen 500 responsive to receiving a movie genre selection from the listing options 502. In a second example, the conditional offer is presented on screen 500 after the user selects a particular movie for on-demand viewing. In certain approaches, the conditional offer is tailored to the specific preferences of a user. For example, control circuitry 304 of a user device or remote server may access a user profile from a database stored in storage 308. The user profile may include viewing preferences, favorite genres, and viewing history. The control circuitry 304 may analyze the user profile to generate a conditional offer with a media asset, conditional price, suggested companion users, or other attributes to make the offer more attractive to a particular user. For example, a profile associated with a first user may identify drama and action as favorite genres, or genres of movies in the user's viewing history. Control circuitry 304 may access the first user profile generate a conditional offer for a movie classified as drama, action, or both. Control circuitry 304 may additionally or alternatively access companion user profiles, find companion users who have also identified drama and action as favorite genres or have recently viewed movies in these categories, and generate a list of suggested companion users. In certain embodiments, control circuitry 304 may access a purchase history within a user profile associated with a user to generate a discounted price in a conditional offer. For example, a user may typically purchase on-demand media content for $3 or less. Control circuitry 304 may then generate a conditional offer for a media asset with a price of $3 or less.

In certain embodiments, control circuitry 304 of a user device or remote server receives a user request to generate a user-defined conditional group purchase offer. The request may include an identification of a media asset, a requested conditional price, a requested minimum quantity of purchases required to receive the asset at the conditional price, a requested time period for purchasing the asset at the conditional price, or a combination thereof. For example, control circuitry 304 of the remote server may receive a user-defined conditional offer request via communications network 414.

Control circuitry 304 analyzes the request to generate a conditional group offer and determines a value factor. The value factor is an assessment of the request, which may incorporate transmission costs, estimated probability of receiving the minimum quantity of purchase requests, recent sales, recent user purchases, availability of the media asset, license agreements, profit margins, and other factors. If the value factor exceeds a predetermined threshold, the control circuitry of a remote server generates the conditional offer and transmits it to a user device, for example, as shown on display screen 500.

The media asset offered in the conditional group purchase offer may include any electronically consumable user asset as described above. In certain embodiments, the media asset is on-demand content that can be purchased and viewed at a time selected by the user. In certain embodiments, the offered media asset is downloadable and may be accessed by the user with one or more devices, including mobile user devices. For example, the media asset may be provided by media content source 416 for delivery through communications network 414 to user device (e.g., television equipment 402, computer equipment 404, or wireless user communication device 406). In certain approaches, the media asset is available only at a specified time. For example, the media asset may be a pay-per-view event, a live event, an event broadcast at a specified time.

Display screen 500 includes a representation 506 of the media asset being offered to the user. In the example depicted in FIG. 5, the conditional offer is for viewing the movie WAR HORSE and representation 506 is a promotional image for WAR HORSE. War Horse is a trademark owned by DreamWorks Pictures. In alternative embodiments, representation 506 may be a movie trailer, video clip from the movie, advertisement, promotional content, or other media content.

Display screen 500 also includes offer details 518, which describe the conditional group purchase offer for the user. In the depicted example, control circuitry 304 of the user equipment displays offer details 518 as text on screen 500. In alternative implementations, the offer details 518 may be provided as images, icons, video, or audio content. The offer details 518 include a price indicator 520. The price indicator 520 displays the conditional purchase price for access to the media asset if the conditions of the offer are met. The price indicator 520 also may also show the discount percent and the standard price of the media asset. In the example depicted in FIG. 5, the conditional price for accessing the movie WAR HORSE is $2, which is 67% off the standard price. The price may be in currency (e.g., dollars), credits (e.g., pre-purchased credits from the media provider), points (e.g., reward points from purchasing other media assets), or other value exchange means. Additionally or alternatively to a reduced price, the conditional offer may include other incentives as described above.

The conditional offer details 518 further include a time indicator 522 for the conditional offer to indicate the time period in which the purchases must be made in order to receive access to the media asset at the conditional price. The time indicator 522 may show when the offer will close by providing a countdown indicating how many days, hours, minutes and seconds remain for purchasing the asset with the conditional offer. In the example depicted in FIG. 5, the time indicator 522 displays a time remaining of “11 Hours 13 Minutes.” In other implementations, the time indicator 522 provides a closing time or date, such as 11:00 p.m. on April 17^{th}. In certain embodiments, for example, when the media asset is scheduled to be broadcast or transmitted at a specific time, such as a live event or pay-per-view program, the time indicator 522 may show when the media asset will be broadcast or otherwise transmitted.

The offer details 518 provided by control circuitry 304 (e.g., of the user equipment or remote server) include a condition indicator 524 to indicate whether the minimum quantity of purchases has been met for the conditional group purchase offer. The condition indicator 524 may be provided as a statement, such as “Minimum Quantity Not Yet Exceeded” as shown in FIG. 5, or “Minimum Quantity Achieved,” or any other appropriate message. In certain approaches, the condition indicator 524 displays how many purchase requests have been received by control circuitry 304 of a remote server or how many purchase requests must still be received to meet the minimum purchase requirement of the conditional offer. The condition indicator 524 may be provided as an image or icon. In one example, the indicator 524 is a progress bar that advances as more purchases are made. In a different example, the indicator 524 is a color icon that displays a first color (e.g., red) to indicate that the minimum quantity of purchases has not been met and a second color (e.g., green) minimum quantity of purchases has been met.

Display screen 500 includes several user input options for collecting responses to the presented conditional offer. In particular, control circuitry 304 of the user equipment provides option buttons 508 on display screen 500. Among the response options, control circuitry 304 of the user equipment or remote server may receive a user selection from the “Watch Now” button 510, which prompts the control circuitry 304 to initiate a purchase of the media asset presented in the conditional offer. In one example, when the control circuitry 304 receives the “Watch Now” user selection, control circuitry 304 of the remote server initiates a purchase of the media asset at a standard price, terminates access to the conditional offer for the user, and transmits the media asset to user equipment via communications network 414. In an alternative embodiment, when control circuitry 304 receives a “Watch Now” user selection, the control circuitry 304 of the remote server provides access to the media asset immediately, but does not initiate a purchase transaction until either the minimum purchase request quantity has been met (e.g., as shown by indicator 524), or the predetermined time period for the conditional offer (e.g., as shown by indicator 522) has expired. Control circuitry 304 of the remote server may receive the purchase requests via the communications network 414 and determine whether the minimum quantity of purchase requests has been received, for example, with an incremental counter. The counter may be stored and accessed by control circuitry 304 in a database with the media asset, purchase requests, and offer specifications (e.g., the conditional price, the minimum quantity of purchases required to receive the asset at the conditional price, the time period for the conditional offer) or a combination thereof. The database may be stored, for example, in memory of remote server 415, such as storage 308 of FIG. 3. If the minimum quantity of purchase requests is received during the conditional time period, then control circuitry 304 of the remote server processes the purchase transaction of the media asset at the discounted, conditional price. If the required number of purchase requests is not received within the conditional time period, then control circuitry 304 processes the purchase transaction at a standard price. In this particular example, the user is provided with the benefit of immediate access to the media content, but maintains the possibility of receiving the media asset at the conditional, discounted price.

Control circuitry 304 of the user device or remote server additionally provides an “Invite Friends” button 512 on screen 500 for initiating electronic invitations to companion users, such as friends or other personal contacts, to participate in the conditional offer. When control circuitry 304 receives an “Invite Friends” user selection, control circuitry 304 transmits an electronic invitation (e.g., email, instant message, text message, etc.) with the specifications for the conditional offer via communications network 414. In certain embodiments, the invitation may include the trailer, a link to the trailer, or other promotional content, such as user reviews. This content may be helpful, for example, when accessing the invitation by email or on a mobile device, and may help the companion user decide to request purchase of the asset. Control circuitry 304 retrieves the contact data corresponding to the identified companion user from a database. In certain embodiments, the contact data is stored in storage 308. Control circuitry 304 additionally generates a message for delivery, including, but not limited to, the conditional offer specifications. Control circuitry 304 uses the contact data to transmit the message including the conditional offer specifications to a user device (e.g., devices 402, 404, 406) via communications network 414. In certain embodiments, the control circuitry 304 transmits the invitation to a user device, such as user equipment 300, on which the companion user may receive access to the media asset. By providing an “Invite Friends” option button 512, a user can be incentivized to request purchase of the media asset and encourage companion users to request purchase of the media asset, thereby increasing the likelihood of meeting the minimum purchase requirement to access the media asset at the conditional price 520. In certain approaches, the number of purchase requests may exceed the minimum quantity required by the conditional offer.

In certain embodiments, the option buttons 508 includes a “Conditional Purchase” button 514. When control circuitry 304 of the user device or remote server receives a “Conditional Purchase” user selection, control circuitry 304 first determines whether the minimum quantity of purchase requests has been received before processing a purchase transaction. Control circuitry 304 of the remote server may receive the purchase requests via communications network 414 and determine whether the minimum quantity of purchase requests has been received. Control circuitry 304 of the user device or remote server only processes the purchase if the minimum quantity is received within the conditional time period. Accordingly, control circuitry 304 does not provide access to the media asset unless the conditions for the offer are met. In certain embodiments, control circuitry 304 of the remote server transmits a notification to user equipment via communications network 414 when the conditions for the offer are met.

In certain implementations of display screen 500, control circuitry 304 of the user device or remote server provides a “Watch Trailer” button 516 among the option buttons 508. When the control circuitry 304 receives a “Watch Trailer” user selection, the control circuitry 304 transmits a movie trailer or other promotional content for the media asset offered through the conditional offer presented on display screen 500. For example, the user may want to learn more about a movie before deciding to purchase the movie. By providing the user with the opportunity to watch the trailer, the user may be more likely to request purchase of the media asset and invite friends to purchase the media asset. In certain embodiments, the user may send the trailer or a link to the trailer or other promotional content with the invitation.

The user may decide not to request purchase of the media asset through the conditional offer. For example, the user may select other options, such as those provided by listing options 502, to watch other on-demand content or to go back to other viewing options. When control circuitry 304 receives an alternative user selection, the control circuitry 304 processes the selection accordingly.

In certain embodiments, control circuitry 304 of the remote server or user device generates an “invitation-based” conditional group purchase offer for a media asset that is conditioned on receiving invitation requests from a user. The media asset is offered at reduced price, but the control circuitry 304 only provides access to the asset at the reduced price if control circuitry 304 receives user invitation requests for inviting companion users (e.g., friends or personal contacts) and a predetermined minimum quantity of purchase requests for the media asset are received within a specified time period. The user is thereby incentivized to invite companion users, such as friends, to request purchase of the asset.

FIG. 6 shows an illustrative display screen 600 presenting a conditional invitation-based group purchase offer for an on-demand media asset. The invitation-based conditional group purchase offer presented to the user by display screen 600 may be generated by control circuitry 304 automatically or responsive to a request from the user of the user device or remote server. For example, the conditional offer may be generated by control circuitry 304 when a user device (e.g., television equipment 402, computer equipment 404, or wireless user communications device 406) is turned on, at periodic intervals (e.g., daily), or according to a predetermined schedule (e.g., on the release date of a movie). In some implementations, control circuitry 304 may generate screen 600 in response to receiving a user request to watch on-demand content by making a selection on screen 100 or 200. For example, control circuitry 304 of the user device or remote server may receive a request to access on-demand option 114 or advertisement 124 of screen 100, or on-demand option 203 of screen 200. In certain embodiments, control circuitry 304 generates the conditional offer in response to receiving a user selection of the “Special Offers” listing 604 on display screen 600. In certain approaches, control circuitry 304 generates screen 600 to a plurality of user devices associated with a plurality of users. For example, control circuitry 304 may transmit the conditional offer to a plurality of user devices associated with users who have requested to receive conditional offers for group purchases of media assets.

The conditional offer may also be generated responsive to a selection of other listing options accessible by the user. In one example, the conditional offer is presented on screen 600 responsive to receiving a movie genre selection from the listing options 602. In a second example, the conditional offer is presented on screen 600 after the user selects a particular movie for on-demand viewing. In certain approaches, the conditional offer is tailored to the specific preferences of a user. For example, control circuitry 304 of the user device or remote server may access a user profile from a database stored in storage 308. The user profile may include viewing preferences, favorite genres, and viewing history. The control circuitry 304 may analyze the user profile to generate a conditional offer with a media asset, conditional price, suggested companion users, or other attributes to make the offer more attractive to a particular user. For example, a profile associated with a first user may identify drama and action as favorite genres, or genres of movies in the user's viewing history. Control circuitry 304 may access the first user profile generate a conditional offer for a movie classified as drama, action, or both. Control circuitry 304 may additionally or alternatively access companion user profiles, find companion users who have also identified drama and action as favorite genres or have recently viewed movies in these categories, and generate a list of suggested companion users. In certain embodiments, control circuitry 304 may access a purchase history within a user profile associated with a user to generate a discounted price in a conditional offer. For example, a user may typically purchase on-demand media content for $3 or less. Control circuitry 304 may then generate a conditional offer for a media asset with a price of $3 or less.

In certain embodiments, control circuitry 304 of the user device or remote server receives a user request to generate a user-defined conditional group purchase offer. The request may include an identification of a media asset, a requested conditional price, a requested minimum quantity of purchases required to receive the asset at the conditional price, a requested time period for purchasing the asset at the conditional price, or a combination thereof. For example, control circuitry 304 of the remote server may receive a user-defined conditional offer request via communications network 414. Additionally or alternatively to a reduced price, the conditional offer may include other incentives, such as enhanced access rights or privileges to the media asset, including, but not limited to, providing access to the media asset on multiple devices (e.g., second screen devices), extending the access period to the media asset (e.g., standard access may be for 1 day and extended access may be for 1 week), providing a high definition version of a media asset instead of a standard definition version, providing credits for receiving additional media assets, or providing additional or exclusive media assets (e.g., “bonus content”).

Control circuitry 304 of the user device or remote server analyzes the request to generate a conditional group offer and determines a value factor. The value factor is an assessment of the request, which may incorporate transmission costs, estimated probability of receiving the minimum quantity of purchase requests, recent sales, recent user purchases, availability of the media asset, license agreements, profit margins, and other factors. If the value factor exceeds a predetermined threshold, the control circuitry 304 generates the conditional offer and transmits it to a user device, for example, as shown on display screen 600.

The media asset offered in the invitation-based conditional group purchase offer may include any electronically consumable user asset as described above. In certain embodiments, the media asset is on-demand content that can be purchased and viewed at a time selected by the user. In certain embodiments, the offered media asset is downloadable and may be accessed by the user with one or more devices, including mobile user devices. For example, the media asset may be provided by media content source 416 for delivery through communications network 414 to user equipment (e.g., television equipment 402, computer equipment 404, or wireless user communication device 406). In certain approaches, the media asset is available only at a specified time. For example, the media asset may be a pay-per-view event, a live event, an event broadcast at a specified time.

Display screen 600 includes a representation 606 of the media asset being offered to the user. In the example depicted in FIG. 6, the conditional offer is for viewing the movie WAR HORSE and representation 606 is a promotional image for WAR HORSE. In alternative embodiments, representation 606 may be a movie trailer, video clip from the movie, advertisement, promotional content, or other media content.

Display screen 600 also includes offer details 618, which describe the invitation-based conditional group purchase offer for the user. In the depicted example, control circuitry 304 of the user device displays offer details 618 as text on screen 600. In alternative implementations, the offer details 618 may be provided as images, icons, video, or audio content. The offer details 618 include a price indicator 620. The price indicator 620 displays the conditional purchase price for access to the media asset if the conditions of the offer are met. The price indicator 620 may also show the discount percent and the standard price of the media asset. In the example depicted in FIG. 6, the conditional price for accessing the movie WAR HORSE is $2, which is 67% off the standard price. The price may be in currency (e.g., dollars), credits (e.g., pre-purchased credits from the media provider), points (e.g., reward points from purchasing other media assets), or other value exchange means. Additionally or alternatively to a reduced price, the conditional offer may include other incentives as described above.

The offer details 618 provided by control circuitry 304 of the user device or remote server include a quantity indicator 624 to indicate how many companion users must purchase the asset in order to receive access to the asset at the conditional group purchase price. For example, in the depicted case, the conditional offer is conditioned on receiving invitation requests at control circuitry 304 from a user, and further receiving at least four purchase requests at control circuitry 304 from invited companion users. In certain embodiments, the quantity indicator displays how many purchases requests have been received by control circuitry 304 or how many purchases requests must still be received to meet the minimum purchase requirement of the conditional offer. The quantity indicator 624 may also be provided as a statement, such as “Minimum Quantity Not Yet Exceeded,” or “Minimum Quantity Achieved,” or any other appropriate message. The quantity indicator 624 may be provided as an image or icon. In one example, after invitations have been sent, the indicator 624 is a progress bar that advances as more purchases are made. In a different example, the indicator 624 is a color icon that displays a first color (e.g., red) to indicate that the minimum quantity of purchases has not been met and a second color (e.g., green) minimum quantity of purchases has been met.

The conditional offer details 618 further include a time indicator 622 for the conditional offer to indicate the time period in which the purchases must be made in order to receive access to the media asset at the conditional price. The time indicator 622 may show when the offer will close by providing a countdown indicating how many days, hours, minutes and seconds remain for purchasing the asset with the conditional offer. In the example depicted in FIG. 6, the time indicator 622 displays a time period of 24 hours for the purchase requests to be made in order to receive the media asset at the conditional price. In other implementations, the time indicator 622 provides a closing time or date, such as 11:00 p.m. on April 17^{th}. In certain embodiments, for example, when the media asset is scheduled to be broadcast or transmitted at a specific time, such as a live event or pay-per-view program, the time indicator 622 may show when the media asset will be broadcast or otherwise transmitted.

Display screen 600 includes several user input options for collecting responses to the presented conditional offer. In particular, control circuitry 304 of the user device provides option buttons 608 on display screen 500. Among the response options, control circuitry 304 of the user device or remote server may receive a user selection from the “Watch Now” button 610, which prompts the control circuitry 304 to initiate a purchase of the media asset presented in the conditional offer. In one example, when the control circuitry 304 receives the “Watch Now” user selection, control circuitry 304 initiates a purchase of the media asset at a standard price, terminates access to the conditional offer for the user, and transmits the media asset to user equipment via communications network 414. In an alternative embodiment, when control circuitry 304 receives a “Watch Now” user selection, the control circuitry 304 provides access to the media asset immediately, but does not initiate a purchase transaction until either the minimum purchase request quantity has been met (e.g., as shown by indicator 624), or the predetermined time period for the conditional offer (e.g., as shown by indicator 622) has expired. Control circuitry 304 of the remote server may receive the purchase requests via communications network 414 and determine whether the minimum quantity of purchase requests has been received, for example, with an incremental counter. The counter may be stored and accessed by control circuitry 304 in a database with the media asset, purchase requests, and offer specifications (e.g., the conditional price, the minimum quantity of purchases required to receive the asset at the conditional price, the time period for the conditional offer) or a combination thereof. The database may be stored, for example, in memory of remote server 415, such as storage 308 of FIG. 3. If the minimum quantity of purchase requests is received during the conditional time period, then control circuitry 304 processes the purchase transaction of the media asset at the discounted, conditional price. If the required number of purchase requests is not received within the conditional time period, then control circuitry 304 processes the purchase transaction at a standard price. In this particular example, the user is provided with the benefit of immediate access to the media content, but maintains the possibility of receiving the media asset at the conditional, discounted price.

Control circuitry 304 of the user device additionally provides an “Invite Friends” button 612 on screen 600 for initiating electronic invitations to companion users, such as friends or other personal contacts, to participate in the conditional offer. In the offer depicted by display screen 600, the user make an “Invite Friends” user selection in order to receive the media asset at the conditional price. When control circuitry 304 of the user device or remote server receives an “Invite Friends” user selection, control circuitry 304 transmits an electronic invitation (e.g., email, instant message, text message, etc.) with the specifications for the conditional offer via communications network 414. In certain embodiments, the invitation may include the trailer, a link to the trailer, or other promotional content, such as user reviews. This content may be helpful, for example, when accessing the invitation by email or on a mobile device, and may help the companion user decide to request purchase of the asset. Control circuitry 304 of the user device or remote server retrieves the contact data corresponding to the identified companion user from a database. In certain embodiments, the contact data is stored in storage 308. Control circuitry 304 additionally generates a message for delivery, including, but not limited to, the conditional offer specifications. Control circuitry 304 uses the contact data to transmit the message including the conditional offer specifications to a user device (e.g., devices 402, 404, 406) via communications network 414. In certain embodiments, the control circuitry 304 transmits the invitation to a user device, such as user equipment 300, on which the companion user may receive access to the media asset.

An “Invite Friends” user selection also includes a purchase request for the media asset. Control circuitry 304 of the user device or remote server will only process the purchase transaction if the minimum quantity of purchase requests are received within the conditional time period. Accordingly, control circuitry 304 does not provide access to the media asset unless the conditions for the offer are met. Although the invitations must result in at least the minimum quantity of users requesting purchase of the media asset, as shown by indicator 624, the control circuitry 304 may receive additional “Invite Friends” user selection requests. The user is incentivized to make “Invite Friends” selections to increase the likelihood of meeting the minimum purchase requirement for obtaining access the media asset at the conditional price 620. In certain approaches, the number of purchase requests may exceed the minimum quantity required by the conditional offer. In certain approaches, the control circuitry 304 of the remote server may receive “Invite Friend” user selections from companion users as well. In certain embodiments, control circuitry 304 of the remote server transmits a notification to user equipment via communications network 414 when the conditions for the offer are met.

In certain implementations of display screen 600, control circuitry 304 of the user device provides a “Watch Trailer” button 616 among the option buttons 608. When the control circuitry 304 of the user device or remote server receives a “Watch Trailer” user selection, the control circuitry 304 transmits a movie trailer or other promotional content for the media asset offered through the conditional offer presented on display screen 600. For example, the user may want to learn more about a movie before deciding to purchase the movie. By providing the user with the opportunity to watch the trailer, the user may be more likely to request purchase of the media asset and invite friends to purchase the media asset. In certain embodiments, the user may send the trailer or a link to the trailer or other promotional content with the invitation.

The user may decide not to request purchase of the media asset through the conditional offer. For example, the user may select other options, such as those provided by listing options 502, to watch other on-demand content or to go back to other viewing options. When control circuitry 304 receives an alternative user selection, the control circuitry processes the selection accordingly.

In certain embodiments, control circuitry 304 of the user device or remote server provides options or screens for selecting companion users to invite to participate in the conditional group purchase offer. The control circuitry 304 of the user equipment may provide display screens to allow users to make invitation selections directly from the user device as part of the request to purchase the media asset. Control circuitry 304 of the user device or remote server may accesses a database from storage 308, which includes contact data for companion users.

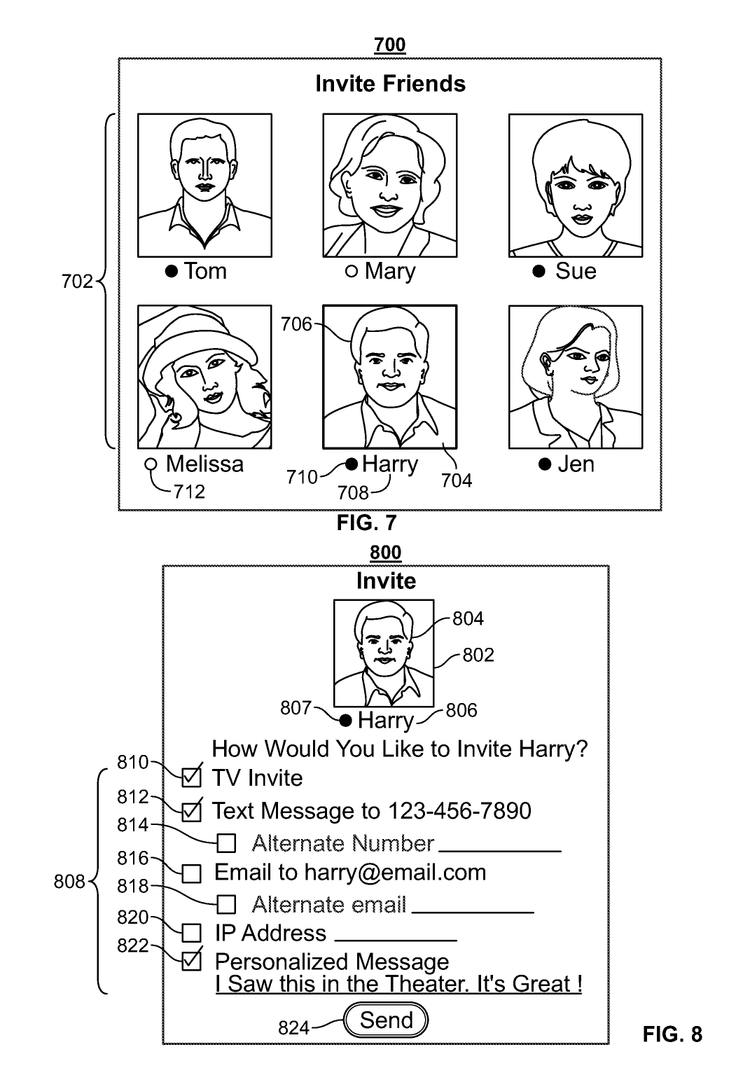

FIG. 7 shows an illustrated display screen for selecting companion users to invite to purchase access to an on-demand media asset through a conditional offer. Display screen 700 provides an interface that allows the user to select one or more companion users for participation in the conditional offer. Display screen 700 is generated by control circuitry 304 of the user equipment responsive to receiving a user request to invite companion users to participate in a conditional offer (e.g., conditional offers presented in display screen 500 and display screen 600). For example, display screen 700 may be generated by control circuitry 304 in response to receiving an “Invite Friends” user selection from button 512 or button 612.

Display screen 700 includes a listing 702 of one or more companion users, to whom the first user is connected. The companion users may be a part of a locally-stored contact list (e.g., in storage 308 of control circuitry 304 of user equipment) or a contact list associated with a second device (e.g., mobile phone), service (e.g., email contacts), or social network (e.g., buddy list or friend list) accessible to control circuitry 304 of the user device or remote server. Control circuitry 304 of the user device or remote server may generate the listing 702 of companion users by connecting with a social network (e.g., FACEBOOK, TWITTER, MYSPACE, or any other such websites or applications), or media application or website (e.g. HULU, NETFLIX, or any other such websites or applications). For example, control circuitry 304 may retrieve login information for the social network website from a database stored in storage 308. Control circuitry 304 may also retrieve login information via user input (e.g., through user input interface 310), or in any other suitable manner. Control circuitry 304 establishes a communications link with the social network website via communications network 414. Control circuitry 304 may access the database to retrieve a contact list and contact details (e.g., screen name, phone number, email, etc.) to generate the listing 702 of companion users. Control circuitry 304 may additionally search for available content such as posts, links, images, documents, audio, video, profiles, status updates, indicated interests or approvals (e.g. a “like” or “fan” indication stored on a social network, such as FACEBOOK), recommendations, viewing history, purchase history, or other suitable information to provide personalized offers or suggestions for companion users who may be interested in purchasing the on-demand media asset. In certain approaches, control circuitry 304 may provide a conditional offer for a movie and search content associated with companion users for content related to the movie. For example, control circuitry 304 may search for content related to the media asset itself, such as links to trailers posted by a user. Control circuitry 304 may search for content related to the movie, such as information posted by users indicating interest in particular genres, actors, actresses, or directors. For example, in order to generate a list of potential companion users to view a super hero action movie, control circuitry 304 may access a post associated with a first companion user, wherein the post discusses an actor or actress in the offered movie. Control circuitry 304 may access a profile associated with a second companion user, wherein the profile indicates that the second companion user is a “fan” of an actor or address in the movie. Control circuitry 304 may access a video posted by a third user from a different superhero action movie. Control circuitry 304 may then provide a list of suggested companion users to the first user that includes the first, second, and third companion users based on the related content associated with each user.

In the depicted example, listing 702 on display screen 700 includes icons, such as icon 704, to represent each companion user. Icon 704 includes a representation 706, such as an image, avatar, or video of the companion user. The icons 704 may include a text identifier 708 for the companion user, such as a name, nickname, or screen name of the companion user. The icons may also include additional information for the companion users, such as a location, favorite media genre, and recently viewed content. In certain implementations, the icon 704 includes a status indicator to indicate whether the companion user is online or otherwise accessible through electronic means. For example, status indicator 710 shows that “Harry” is online, while status indicator 712 shows that “Melissa” is not online. Control circuitry 304 of the user device or remote server may electronically communicate with user equipment of the companion users or services via communications network 414 to determine the status of individual users. The text identifiers 708 and status indicators 710 and 712 allow the user to make informed decisions for sending an invitation to request purchase of the media asset through the conditional offer and increase the likelihood of meeting the required minimum quantity of purchases of the offer.

In addition to selecting which users to invite, certain embodiments provide means to allow the user to select different electronic communication means for sending the invitations. For example, control circuitry 304 may send the invitation to any appropriate user device through communications network 414.

FIG. 8 shows an illustrated display screen for selecting a method of inviting a companion user. Display screen 800 of FIG. 8 may be generated by control circuitry 304 of the user device or remote server responsive to receiving a user selection to invite a companion user, as described in connection with screen 700. In the depicted example, the control circuitry 304 (e.g., of the user device) received a user selection requesting to invite “Harry” to participate in the conditional offer, and accordingly displays screen 800 for selecting a method of inviting “Harry” to request purchase of the media asset with the conditional offer. Display screen 800 may include an icon 802 to represent the companion user. The icon 802 includes a representation 804 of the companion user, a text identifier 806, and a online status indicator 807. Display screen 800 may include contact information for the companion user from a locally stored contact list, or a contact list associated with a user device (e.g., mobile phone), service (e.g., email contacts), or social network (e.g., buddy list or friend list). For example, control circuitry 304 of the user device or remote server may access a database from storage 308. Additionally or alternatively, control circuitry 304 may access a social network or service through communications network 414 as described previously.

Control circuitry 304 of the user device or remote server provides a plurality of invitation options 808 on display screen 600. In particular, control circuitry 304 provides selection options to send an invitation by one or more invitations options 810-822 and “Send” button 824. When control circuitry 304 receives an invitation selection from options 810-822 and a send request from button 824, control circuitry 304 generates a message for delivery, including, but not limited to, the conditional offer specifications. Control circuitry 304 uses the contact data to transmit the message including the conditional offer specifications to a user device (e.g., devices 402, 404, 406) via communications network 414. In certain embodiments, the control circuitry 304 transmits the invitation to a user device on which the companion user may receive access to the media asset.

Among the response options, control circuitry 304 of the user device or remote server provides an option to send the invitation to companion user equipment by selecting option 810. In certain embodiments, when a user equipment invitation option 810 is received, control circuitry 304 transmits an invitation with a description of the conditional offer user equipment of the companion user. The control circuitry 304 of the companion equipment displays the conditional offer when the companion user is viewing or otherwise accessing the user equipment. In certain approaches, the invitation appears as a notification on a display (e.g., display 312) or an audible tone (e.g., via speakers 314) on the user equipment. In certain embodiments, control circuitry 304 of the user equipment provides the notification on an interactive program guide.

Additionally provided by control circuitry 304 of the user device or remote server is an option to deliver the invitation by text message by selecting option 812 or option 814. Option 812 uses a stored texting number (e.g., mobile phone number), while option 814 allows the user to provide an alternate texting number. When control circuitry 304 of the user device or remote server sends a text message invitation, the companion user may receive the invitation even if the companion user is not currently online or watching television. In certain implementations, the control circuitry 304 of the remote server may receive a purchase request from a companion through a mobile device. In certain embodiments, the control circuitry 304 of the remote server transmits the media asset to a mobile device of the companion user.

Additionally provided by control circuitry 304 of the user device or remote server is an option to delivery the invitation by email with option 816 or 818. Option 816 uses a stored email address, while option 818 allows the user to provide an alternate email address. When control circuitry 304 sends an email message, the companion user may receive the invitation even if the companion user is not currently online or watching television. In certain implementations, control circuitry 304 may receive an IP address to send the invitation with option 820. The IP address may be associated with a particular location or device of the companion user.

Also provided by control circuitry 304 of the user device or remote server on display screen 800 is an option to send a personal message by selecting option 822. The user may enter a personal message to encourage the companion user to participate in the conditional offer and purchase the media asset. The control circuitry receives the personal message and transmits the personal message with the invitation to the user equipment. For example, as shown in FIG. 8, the user has entered a message, “I saw this in the theater. It's great!” The personal message may include text, images, videos, links or other multimedia content, such as links to an online review. In certain embodiments, the message includes a list of other friends or companion users who have also been invited to participate in the conditional offer.

When control circuitry 304 of the user device or remote server generates and transmits an invitation for companion users, the control circuitry 304 also generates an input means for responding to the invitation on the user equipment of the companion users. For example, control circuitry 304 may generate an interactive program guide on a display 312 of user equipment 300.

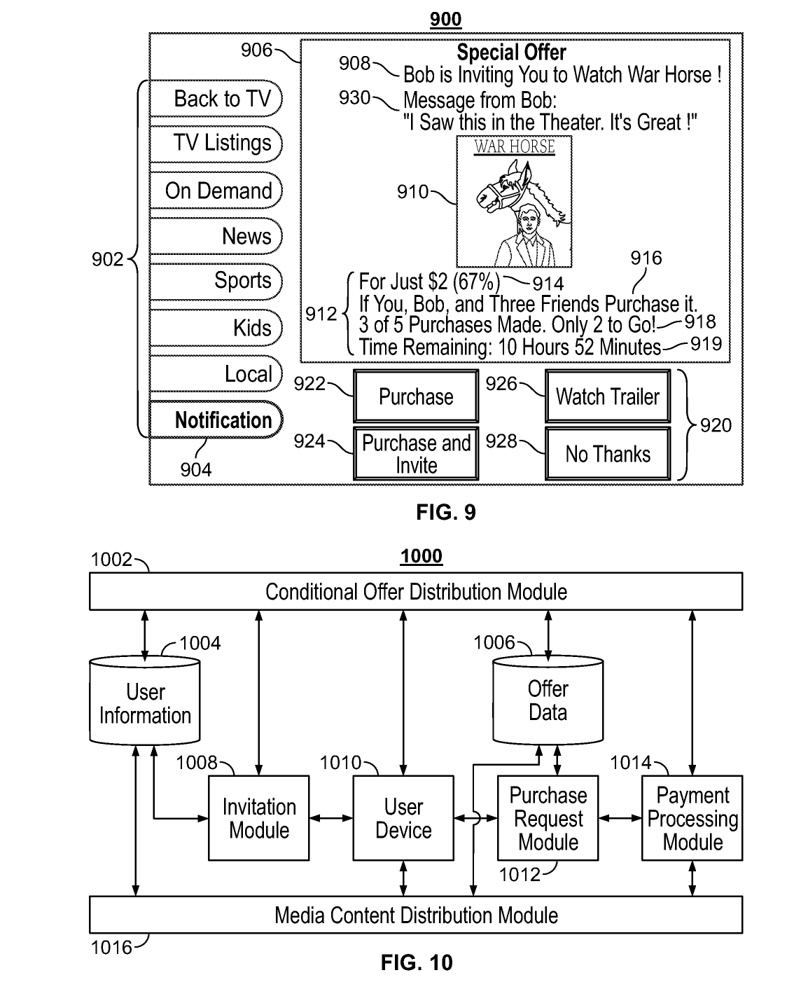

FIG. 9 shows an illustrative display screen for displaying an invitation to a companion user to participate in a conditional group purchase offer for an on-demand media asset. Display screen 900 is generated by control circuitry 304 of the user equipment and includes an invitation window 906, which presents the conditional offer to the companion user. The media asset is offered at a reduced price, but the control circuitry 304 (e.g., of the user device or remote server) provides access to the asset at the reduced price only if a predetermined minimum quantity of purchase requests are received for the media asset within a specified time period. The invitation is transmitted by the control circuitry 304 to the companion user in response to a request from a first user. For example, control circuitry 304 of the user equipment or remote server may transmit the invitation via communications network 414, as described above.

The invitation window 906 may be generated by control circuitry 304 automatically or responsive to a request from the companion user. For example, control circuitry 304 of the user equipment may provide a “Notification” option 904 among viewing options 902 when an invitation is received. When control circuitry 304 receives a selection of the “Notification” option 904, control circuitry 304 generates invitation window 906. In some implementations, control circuitry 304 generates invitation window 906 automatically when an invitation is received.

Display screen 900 includes a representation 910 of the media asset being offered to the user. In the example depicted in FIG. 9, the conditional offer is for viewing the movie WAR HORSE and representation 910 is a promotional image for WAR HORSE. In alternative embodiments, representation 910 may be a movie trailer, video clip from the movie, advertisement, promotional content, or other media content.

Display screen 900 may also include other features to present the conditional offer to the companion user. For example, control circuitry 304 of the user equipment may generate an invitation message 908 identifying the window 906 as an invitation to access a media asset. The invitation message may identify the first user who initiated the invitation (e.g., “Bob”) and the media asset being offered (e.g., WAR HORSE). In certain implementations the invitation window 906 may include a personal message 930 from the user who initiated the invitation. For example, as shown in FIG. 9, the first user has entered a message, “I saw this in the theater. It's great!” In certain embodiments, the personal message is received from a first user, for example, by option 822 of screen 800.

Display screen 900 also includes offer details 912, which describe the conditional group purchase offer for the user. In the depicted example, control circuitry of the user equipment 304 displays the offer details 912 as text on screen 900. In alternative implementations the offer details 912 may be provided as images, icons, video, or audio content. The offer details 912 include a price indicator 914. The price indicator 914 displays the conditional price that the user will pay for access to the media asset if the conditions of the offer are met. The price indicator 914 may also show the discount percent and the standard price of the media asset. In the example depicted in FIG. 9, the conditional price for accessing the movie WAR HORSE is $2, which is 67% off the standard price. The price may be in currency (e.g., dollars), credits (e.g., pre-purchased credits from the media provider), points (e.g., reward points from purchasing other media assets), or other value exchange means.

The offer details 912 provided by control circuitry 304 of the user equipment or remote server include a quantity indicator 916 to indicate how many companion users must purchase the asset in order to receive access to the asset at the conditional group purchase price. For example, in the depicted case, the conditional offer is conditioned on receiving invitation requests at control circuitry 304 from three additional friends or companion users.

The offer details 912 further include a condition indicator 918 to indicate whether the minimum quantity of purchases has been met for the conditional group purchase offer. In certain approaches, the condition indicator 918 displays how many purchase requests have been received by control circuitry 304 (e.g., of the remote server), how many purchases must still be made to meet the minimum purchase requirement of the conditional offer, or both. The condition indicator 918 may be provided as a statement, such as “3 of 5 Purchase Made. Only 2 to Go!” as shown in FIG. 9, or, “Minimum Purchase Quantity Achieved!” or any other appropriate message. The condition indicator 918 may be provided as an image or icon. In one example, the indicator 918 is a progress bar that advances as more purchases are made. In a different example, the indicator 918 is a color icon that displays a first color (e.g., red) to indicate that the minimum quantity of purchases has not been met and a second color (e.g., green) if the minimum quantity of purchases has been met.

The conditional details 912 further include a time indicator 919 for the conditional offer to indicate the time period in which the purchases must be made in order to receive access to the media asset at the conditional price. The time indicator 919 may show when the offer will close by providing a countdown indicating how many days, hours, minutes and seconds remain for purchasing asset with the conditional offer. In the example depicted in FIG. 9, the time indicator 919 displays a time remaining of “10 Hours 52 Minutes.” In other implementations, the time indicator 917 provides a closing time or date, such as 11:00 p.m. on April 17^{th}. In certain embodiments, for example, when the media asset is scheduled to be broadcast or transmitted at a specific time, such as a live event or pay-per-view program, the time indicator 919 may show when the media asset will be broadcast or otherwise transmitted.

Display screen 900 includes several user input options for collecting responses to the presented conditional offer. In particular, control circuitry 304 of the user equipment provides option buttons 920 on display screen 900. Among the response options, control circuitry 304 of the user equipment or remote server may receive a user selection from the “Purchase” button 922, which prompts the control circuitry 304 to receive a purchase request for the media asset presented in the conditional offer. Control circuitry 304 performs the transaction only if the conditions of the offer are met, i.e. the minimum quantity of purchase requests is received within the conditional time period. Accordingly, control circuitry 304 does not provide access to the media asset unless the conditions for the offer are met. Control circuitry 304 may receive the purchase requests via communications network 414 and determine whether the minimum quantity of purchase requests has been received, for example, but incrementing a purchase request counter. The counter may be stored and accessed by control circuitry 304 in a database with the media asset, purchase requests, and offer specifications (e.g., the conditional price, the minimum quantity of purchases required to receive the asset at the conditional price, the time period for the conditional offer) or a combination thereof. The database may be stored, for example, in memory of remote server 415, such as storage 308 of FIG. 3. In certain embodiments, control circuitry 304 transmits a notification to user equipment via communications network 414 when the conditions for the offer are met.

In an alternative embodiment, when the control circuitry 304 of the user equipment or remote server receives a user request from the “Purchase” button 922, the control circuitry 304 provides access the media content immediately, but the purchase does not initiate the purchase transaction until either the minimum purchase request quantity is received (e.g., as shown by indicator 918), or the predetermined time period for the conditional offer (e.g., as shown by indicator 919) has expired. If the minimum quantity of purchase requests from companion users is received during the conditional time period, then the control circuitry 304 processes the purchase of the media asset at the discounted, conditional price. If the required number of purchase requests is not received within the conditional time period, then control circuitry 304 processes the purchase at the standard price.

In an alternative embodiment, when the control circuitry 304 of the user equipment or remote server receives a user selection from the “Purchase” button 922, control circuitry 304 generates a user option to initiate the purchase immediately at a standard price to access the media asset. For example, control circuitry 304 may transmit, via communications network 414, an on-demand video to a user device (e.g., such as television equipment 402, computer equipment 404, or wireless user communications device 406).

In certain implementations of display screen 900, control circuitry 304 provides a “Purchase and Invite” button 924. When control circuitry 304 receives a “Purchase and Invite” selection from button 924, control circuitry 304 initiates a conditional purchase and generates a selection option to invite additional companion users, such as friends or other personal contacts, to participate in the conditional offer. Control circuitry 304 processes the purchase request only if the minimum quantity of total purchase requests is received. Accordingly, control circuitry 304 does not provide access to the media asset unless the conditions for the offer are met. The control circuitry provides companion user invitation options, such as those described in connection with display screen 700 and display screen 800. If a request to invite a companion user is received by the control circuitry 304, the control circuitry generates and transmits an invitation, as described above.

In certain implementations of display screen 900, control circuitry 304 of the user equipment provides a “Watch Trailer” button 926 among the option buttons 920. When the control circuitry 304 of the user equipment or remote server receives a “Watch Trailer” user selection, the control circuitry 304 transmits a movie trailer or other promotional content for the media asset offered through the conditional offer presented on display screen 900. For example, the companion user may want to learn more about a movie before deciding to purchase the movie. By providing the companion user with the opportunity to watch the trailer, the user may be more likely to request purchase of the media asset and invite friends to purchase the media asset.

The user may decide not to request purchase of the media asset through the conditional offer. In certain examples, the control circuitry 304 of the user device provides a “No Thanks” button 928. When the control circuitry 304 of the user equipment or remote server receives a user selection from the “No Thanks” button, control circuitry 304 terminates the conditional offer for that user. Other selection options to watch other on-demand content or to go back to other viewing options, such as those provided by listing options 902, may still be available.

Users may access conditional offers, content, and the media guidance application (and its display screens described above) from one or more of their user equipment devices. The devices may be configured as described above in relation to FIG. 3 and FIG. 4. Additional details describing system for providing a conditional offer are described below in connection with FIG. 10.

FIG. 10 shows an illustrative system for providing a conditional offer for a media asset and distributing the media asset. In particular, system 1000 illustrates various servers, modules, data stores, and devices that may communicate in order to (a) generate a conditional offer for a media asset, (b) provide the conditional offer to a user, (c) process user purchases, and (d) distribute the media asset. As will be described in more detail below, these servers, modules, data stores, and devices of system 1000 may be used individually or in combination to generate conditional offers and distribute media assets, or otherwise perform the functions discussed below.

Conditional offer distribution module 1002 generates and distributes conditional offers for accessing a media asset. Conditional offer distribution module 1002 may include any suitable hardware for receiving and processing requests, retrieving information from one or more data stores, and providing data to remote devices, such as those described above in connection with FIG. 3 and FIG. 4. For example, conditional offer distribution module 1002 may be a server accessible through communications network 414, and may include one or more general-purpose processors and/or other processing circuitry which may in turn execute software. Conditional offer distribution module 1002 may be, for example, user equipment 300 or control circuitry 304 of FIG. 3. Conditional offer distribution module 1002 may be, for example, remote server 415, media content source 416, or media guidance data source 418 of FIG. 4 or a different server connected to network 414 of FIG. 4. As shown, conditional offer distribution module 1002 may communicate with user information data store 1004, offer data 1006, invitation module 1008, user device 1010, purchase request module 1012, and/or payment processing module 1014. In some embodiments, conditional offer distribution module 1002 and media content distribution module 1016 are conceptual parts of a single module that performs the functions of each, as discussed in greater detail below.

Conditional offer distribution module 1002 may generate a conditional offer automatically or responsive to external input. In some approaches, a conditional offer is generated by conditional offer distribution module 1002 when the user device 1010 is turned on, at periodic intervals, when initiated by the user, and/or at any other suitable time. User device 1010 may be user equipment 300, or may be one of devices 402, 404, or 406. In other approaches, a conditional offer is generated according to predetermined schedule, for example, daily. In some approaches, the conditional offer is generated when the user accesses a user interface, such as screen 100 or screen 200.

In certain embodiments, conditional offer distribution module 1002 generates a conditional offer responsive to receiving a request to access an on-demand media asset from a user device. For example, distribution module 1002 may receive a request to access on-demand option 114 or advertisement 124 of screen 100, or on-demand option 203 of screen 100. In certain implementations, distribution module 1002 receives a request to access an on-demand media asset from a software application running on user device 1010. The application may be a proprietary “app” downloaded from remote server 415 or media content source 416 via communications network 414.

Furthermore, conditional offer distribution module 1002 may access user information database 1004 to generate a conditional offer. For instance, user information database 1004 may include a user profile, user preferences, viewing history, purchase history, and friend or companion user lists with corresponding profiles and history, which conditional offer distribution module 1002 may access to generate a conditional offer. The user information database 1004 may be stored by control circuitry 304 of the user equipment or remote server on storage 308. Control circuitry 304 may receive user input from user input interface 310, and store the input to the user information database 1004. In certain embodiments, control circuitry 304 records a viewing history and/or purchase history to the user data 1004. In certain embodiments, the user information database 1004 is associated with a user device, service, or social network, which is accessed by control circuitry 304, as described above.

Conditional offer distribution module 1002 generates specifications defining the offer. In certain approaches, the specifications include a media asset to be offered to users, a standard price for the media asset, a discounted price for the asset, a minimum quantity of purchases to be made to receive the asset at the discounted price, and a specified time period within which the purchases must be made. Additionally or alternatively to a reduced price, the conditional offer may include other incentives, such as enhanced access rights or privileges to the media asset, including, but not limited to, providing access to the media asset on multiple devices (e.g., second screen devices), extending the access period to the media asset (e.g., standard access may be for 1 day and extended access may be for 1 week), providing a high definition version of a media asset instead of a standard definition version, providing credits for receiving additional media assets, or providing additional or exclusive media assets (e.g., “bonus content”). The conditional offer may also include suggestions for companion users who may be interested in accessing the media asset, suggestions for other media assets, or additional conditional offers. The conditional offer may include the Internet Protocol (IP) address for the user device 1010. In addition, a conditional offer may include a unique identifier for the user of the device, such that that distribution module 1002 or another server, such as remote server 415, may subsequently access and/or modify user data 1004 associated with the user, which may be stored in a remote data store, e.g., the user's profile, conditional offer details, purchase history, subscription information, or other user data.

Conditional offer distribution module 1002 provides invitation module 1008 with the conditional offer. Upon receiving the conditional offer, invitation module 1008 transmits an invitation to participate in the conditional offer to user device 1010. For example, the invitation may be transmitted by control circuitry 304 of the user equipment or remote server through communications network 414, using the IP address for the user device 1010.

Conditional offer distribution module 1002 may additionally transmit the specifications of the conditional offer to data store 1006. Offer data store 1006 is a database that stores pertinent information for the conditional offer, including the media asset, offer specifications (e.g., the conditional price, the minimum quantity of purchases required to receive the asset at the conditional price, the time period for the conditional offer), a counter to track the number of purchase requests, identification of users requesting purchases of the media asset, and identification of users declining purchase of the media asset. The offer data store 1006 may be stored in storage 308 and accessed by control circuitry 304 of the user equipment or remote server. In certain embodiments, the offer data store is stored in memory of remote server 415.

In certain embodiments, a user may choose to invite additional companion users to participate in the conditional offer. The user device 1010 receives the request to invite additional companion users, and identification of the companion users, and then transmits the request to the offer distribution module 1002. Offer distribution module 1002 may then transmit the conditional offer through communications network 414 to additional user devices. The conditional offer module 1002 communicates with the invitation module 1008 to send invitations to the companion user devices. The conditional offer distribution module 1002 may additionally access user information 1004 corresponding to the companion users and transmit the companion user to offer data store 1006.

Purchase request module 1012 receives requests to purchase the media asset. The quantity of purchase requests is stored in the offer data store 1006. The purchase request may include payment account information such as credit card, PayPal, bank account, or other account processing information with permission to access the payment account for processing the purchase when a sufficient quantity of purchases are requested. PayPal is a trademark owned by eBay Inc. If the minimum quantity of purchases requests are received by purchase request module 1012, payment processing module 1014 processing the purchase transaction. For example, payment processing module 1014 may charge the credit card, PayPal, or bank account. In certain embodiments, the payment is added as a charge to the user's service provider account, such as on a cable or Internet service provider bill. In certain implementations, the payment processing module 1014 processes the purchase request even if the minimum quantity of purchases is not received by purchase request module 1012. For example, a user may be willing to purchase the media asset at a standard price in order to access the media asset immediately, or to access the media asset even if the minimum quantity of purchases is not received.

Media content distribution module 1016 distributes the media asset. Media content distribution module 1016 may be, for example, user equipment 300 or control circuitry 304 of FIG. 3. Media content distribution module 1016 may be, for example, remote server 415, media content source 416, or media guidance data source 418 of FIG. 4 or a different server connected to network 414 of FIG. 4. In one example, media content distribution module 1016 distributes the media asset to a user device 1010 by control circuitry 304 of a remote server if the minimum quantity of purchase requests are received by purchase request module 1012 within the predetermined time. Media content distribution module 1016 may transmit the media asset to user device 1010 via communications network 414. If purchase request module 1012 does not receive the minimum quantity of purchase requests within the predetermined time, media content distribution module 1016 does not distribute the media asset. In certain approaches, purchase request module 1012 may receive purchase requests for the media asset even if the conditions of the offer are not met, in which case the media content distribution module 1016 distributes the media asset.

In certain embodiments, the media content distribution module 1016 transmits the media asset to a plurality of user devices 1010 to provide synchronized group access to the media asset. For example, companion users may view a media asset simultaneously on different devices to provide a social connection. In certain approaches, the conditional group purchase offer may include one or more viewing time options. When replying to an invitation to participate in conditional group purchase offer, a user may suggest or select a viewing time, which is then received by offer distribution module 1002. In certain approaches, if the minimum quantity of purchases is met, the conditional offer distribution module distributes a viewing time selection request, whereby users may respond with a viewing time selection, which is then received by conditional offer distribution module 1002. In certain embodiments, conditional offer distribution module 1002 provides a scheduler, such as an online calendar, that may be accessed by a plurality of users simultaneously via a communications network, such as communications network 414. In certain approaches, the users may additionally or alternatively indicate companion users, with whom they would like to synchronize viewing of the media asset. When the viewing time and is scheduled, conditional offer distribution module provides the media content distribution module 1016 with the viewing time and identification of user devices 1010 associated with users who requested purchase of the media asset. Media content distribution module 1016 then enables access to the media asset to the user devices 1010 associated with users who requested purchase of the media asset at the determined time to provide synchronized group access to the media asset. In certain embodiments, the media asset is accessed through a social network application or website.

The following flow diagrams serve to illustrate processes involved in some embodiments of the present disclosure. Where appropriate, these processes may, for example, be implemented completely in the processing circuitry of a user equipment device (e.g., processing circuitry 304 of FIG. 3) or may be implemented at least partially in a source remote from the user equipment devices (e.g., media guidance source 418 of FIG. 4 or modules 1002, 1008, 1010, 1012, 1014, or 1016 of FIG. 10).

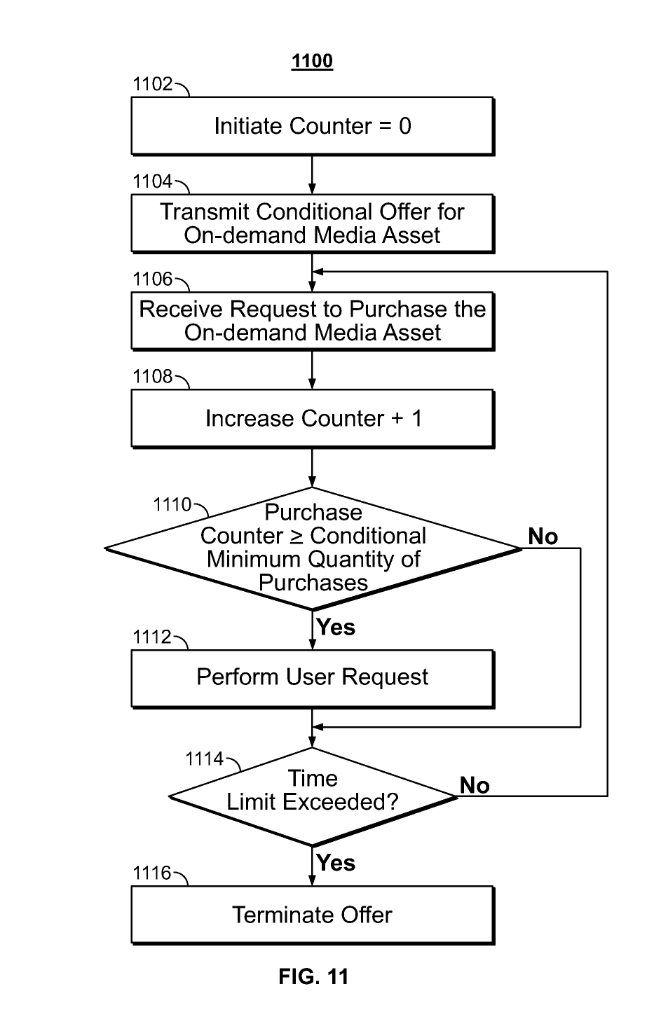

FIG. 11 illustrates a flow diagram for providing a conditional offer to view an on-demand media asset in accordance with some embodiments of the present disclosure. The steps of flow diagram 1100 are performed by a processing device, such as control circuitry 304 of FIG. 3. In certain embodiments, remote server 415 performs the steps of flow diagram 1100. In certain embodiments, the steps of flow diagram 1100 are performed by a user device. Additionally or alternatively, the steps of flow diagram 1100 may be performed by the servers, modules, data stores, and devices 1000. Specifically, the steps of flow diagram 1100 may be performed by the conditional offer distribution module 1002 of system 1000.

At step 1102, the processing device initializes a counter to zero (0). The counter is used by the processing device to track the number of purchase requests for the media asset that is to be offered in a conditional group purchase offer. The counter may be implemented by control circuitry 304 of FIG. 3, and, in certain approaches, may be stored in a database such as offer data store 1006 of FIG. 10. At step 1104 the conditional group offer for an on-demand media asset is transmitted to a user. As discussed above, the conditional offer may be transmitted to the display of a user device, such as display 312 of user equipment 300 of FIG. 3, television equipment 402, computer equipment 404, wireless user communications device 406 of FIG. 4, or user device 1010 of FIG. 10. The conditional offer may be transmitted by the processing device via communications network 414. The conditional offer may be transmitted to an individual user device or, in certain embodiments, may be transmitted to a plurality of user devices. For example, the processing device may transmit the conditional offer to a plurality of users who have requested to receive conditional offers for group purchases of media assets. In certain approaches, users receive the conditional group purchase responsive to requesting access to the conditional group purchase offer, for example, by accessing on-demand option 114 or advertisement 124 of screen 100, or on-demand option 203 of screen 100. The conditional offer may include a promotional discount price for the media asset, which price is conditioned on receiving a minimum quantity of purchase requests within a predetermined period of time. Additionally or alternatively to a reduced price, the conditional offer may include other incentives, such as enhanced access rights or privileges to the media asset as described above.

In certain approaches, the processing device which performs the steps of flow diagram 1100 may include a database to store the media asset, counter, purchase requests, and offer specifications, including the conditional price, the minimum quantity of purchases required to receive the asset at the conditional price, the time period for the conditional offer, or a combination thereof. The database may be stored, for example, in storage 308 of FIG. 3, memory of remote server 415 of FIG. 4, or offer data store 1006 of FIG. 10. The database may be modified and accessed by the control circuitry (e.g., control circuitry 304) of the remote server 415.

At step 1106 a request to purchase the on-demand media asset is received by the processing device. The request may be received, for example, at purchase request module 1012 of FIG. 10. In certain approaches, the purchase requests are received from users who are identified and/or invited by a first user or group of users. Additionally or alternatively, the user requests may be received from users who were not identified and/or invited by another user. The request to purchase is a commitment from a user to purchase the media asset at the conditional price if a sufficient quantity of additional requests are made for the media asset. The purchase request may include payment account information such as credit card, PayPal, bank account, or other account processing information with permission to access the payment account for processing the purchase when a sufficient quantity of purchases are requested. In certain implementations, the purchase request is a commitment to purchase the media asset even if the conditions of the conditional offer are not met. For example, a user may be willing to purchase the media asset at a standard price in order to access the media asset immediately, or to access the media asset even if the minimum quantity of purchases is not received. At step 1108, the processing device increases the counter by one (1), in response to receiving a request to purchase the on-demand media asset at step 1106. The processing device tracks the number of purchase requests for the media asset with the counter.

At step 1110, the processing device determines whether the quantity of purchase requests exceeds the conditional minimum quantity of purchases by comparing the purchase counter to the minimum quantity of purchases required for conditional offer. If the conditional minimum quantity of purchases has not been met, the processing device executes step 1114 to determine whether the time limit for the conditional offer has been exceeded. If the time limit for the offer has not been exceeded, the processing device proceeds to step 1106 to receive additional requests to purchase the on-demand media asset. As additional requests are received at step 1106, the processing device increases the counter by one (1) at step 1108 with each purchase request. These steps are be performed by the processing device until either the purchase counter exceeds the conditional minimum quantity of purchases at step 1110 or the time limit for the conditional limit is exceeded at step 1114.

If, at step 1110, the purchase counter exceeds the conditional minimum quantity of purchases, the processing device executes step 1112 to perform a user request. The user request may include providing access to the media asset. In certain embodiments, for example, when the media asset is scheduled to be broadcast or transmitted at a specific time (e.g., a live event or pay-per-view program), the processing device performs the user request at step 1112 by broadcasting or otherwise transmitting the media asset at the specified time. In some approaches, performing the user request may include processing payment for the media asset. After performing the user request at step 1112, the processing device proceeds to step 1114 to determine if the time limit has been exceeded. If the time limit has not been exceeded, the processing device performs step 1106 and continues to receive requests to purchase the on-demand media asset. When the time limit has been exceeded, the processing device proceeds to step 1116 to terminate the offer. When the offer is terminated at step 1116, no additional purchase requests can be received for the transmitted conditional offer. If a sufficient quantity of purchase requests was received to meet the conditional minimum quantity of purchases as determined at step 1110, then the processing device will process the purchase requests and transmit the on-demand media asset to the users who made purchase request requests. However, if an insufficient quantity of purchase requests was received, those users who made the purchase requests will not be granted access to the on-demand media asset at the conditional price. In certain embodiments, the processing device transmits the media asset to a plurality of user devices to provide synchronized group access to the media asset. For example, companion users may view a media asset simultaneously on different devices to provide a social connection. In certain embodiments, the media asset is accessed through a social network application or website.

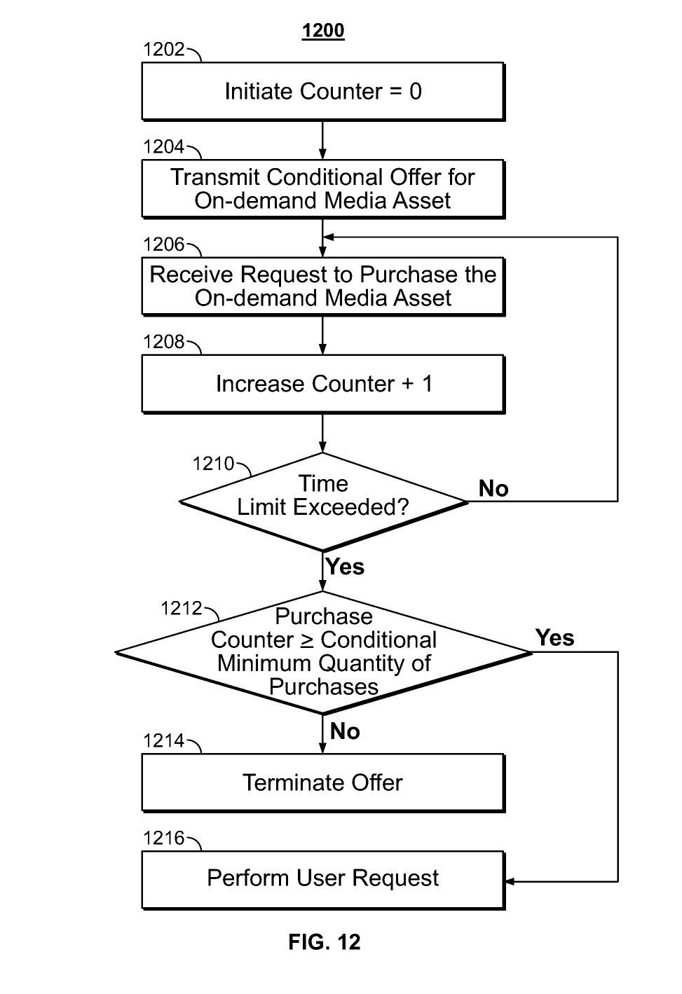

In certain embodiments, the steps performed by the processing device in flow diagram 1100 may be performed in different orders. For example, the processing device may determine whether the time limit has been exceeded before determining whether the minimum quantity of purchase offers was received. In this way, as will be described in further detail as related to FIG. 12, the processing device continues to receive the purchase requests continually without performing additional actions until the time limit is exceeded.

FIG. 12 illustrates a flow diagram for providing a conditional offer to view an on-demand media asset in accordance with some embodiments of the present disclosure. The steps of flow diagram 1200 are performed by a processing device, such as control circuitry 304 of FIG. 3. In certain embodiments, remote server 415 performs the steps of flow diagram 1200. In certain embodiments, the steps of flow diagram 1200 are performed by a user device. Additionally or alternatively, the steps of flow diagram 1200 may be performed by the servers, modules, data stores, and devices 1000. Specifically, the steps of flow diagram 1200 may be performed by the conditional offer distribution module 1002 of system 1000.

At step 1202, the processing device of the user equipment or remote server initializes a counter to zero (0). The counter is used by the processing device to track the number of purchase requests for the media asset that is to be offered in a conditional group purchase offer. The counter may be implemented by control circuitry 304 of FIG. 3, and in certain approaches may be stored in a database such as offer data store 1006 of FIG. 10. At step 1204 the conditional group offer for an on-demand media asset is transmitted to a user device. As discussed above, the conditional offer may be transmitted to the display of a user device, such as display 312 of user equipment 300 of FIG. 3, television equipment 402, computer equipment 404, wireless user communications device 406 of FIG. 4, or user device 1010 of FIG. 10. The conditional offer may be transmitted by the processing device via communications network 414 to an individual user device or, in certain embodiments, may be transmitted to a plurality of user devices. For example, the processing device may transmit the conditional offer to a plurality of users who have requested to receive conditional offers for group purchases of media assets. In certain approaches, users receive the conditional group purchase responsive to requesting access to the conditional group purchase offer, for example, by accessing on-demand option 114 or advertisement 124 of screen 100, or on-demand option 203 of screen 100. The conditional offer may include a promotional discount price for the media asset, which price is conditioned on receiving a minimum quantity of purchase requests within a predetermined period of time. Additionally or alternatively to a reduced price, the conditional offer may include other incentives, such as enhanced access rights or privileges to the media asset as described above.

In certain approaches, the processing device which performs the steps of flow diagram 1200 may include a database to store the media asset, counter, purchase requests, and offer specifications, including the conditional price, the minimum quantity of purchases required to receive the asset at the conditional price, the time period for the conditional offer, or a combination thereof. The database may be stored, for example, in storage 308 of FIG. 3, memory of remote server 415 of FIG. 4, or offer data store 1006 of FIG. 10. The database may be modified and accessed by the control circuitry (e.g., control circuitry 304) of the remote server 415.

At step 1206 a request to purchase the on-demand media asset is received by the processing device. The request may be received, for example, at purchase request module 1012 of FIG. 10. In certain approaches, the purchase requests are received from users who are identified and/or invited by a first user or group of users. Additionally or alternatively, the user requests may be received from users who were not identified and/or invited by another user. The request to purchase is a commitment from a user to purchase the media asset at the conditional price if a sufficient quantity of additional requests are made for the media asset. The purchase request may include payment account information such as credit card, PayPal, bank account, or other account processing information with permission to access the payment account for processing the purchase when a sufficient quantity of purchases are requested. In certain implementations, the purchase request is a commitment to purchase the media asset even if the conditions of the conditional offer are not met. For example, a user may be willing to purchase the media asset at a standard price in order to access the media asset immediately, or to access the media asset even if the minimum quantity of purchases is not received. At step 1208, the processing device increases the counter by one (1), in response to receiving a request to purchase the on-demand media asset at step 1206. The processing device tracks the number of purchase requests for the media asset with the counter.

At step 1210, the processing device determines whether the time limit for the conditional offer has been exceeded. If the time limit for the offer has not been exceeded, the processing device proceeds to step 1206 to receive additional requests to purchase the on-demand media asset. As additional requests are received at step 1106, the processing device increases the counter by one (1) at step 1208 with each purchase request. These processes are performed by the processing device until the time limit for the conditional limit is exceeded at step 1214.

After the time limit is exceeded, the processing device performs step 1212 to determine whether the quantity of purchase requests exceeds the conditional minimum quantity of purchases by comparing the purchase counter to the minimum quantity of purchases required for the conditional offer. If the conditional minimum quantity of purchases has not been met, the processing device executes step 1214 to terminate the offer. When the offer is terminated at step 1214, no additional purchase requests can be received for the transmitted conditional offer. If, at step 1212, the purchase counter exceeds the conditional minimum quantity of purchases, the processing device executes step 1216 to perform a user request. The user request may include providing access to the media asset. In certain embodiments, for example, when the media asset is scheduled to be broadcast or transmitted at a specific time (e.g., a live event or pay-per-view program), the processing device performs the user request at step 1216 by broadcasting or otherwise transmitting the media asset at the specified time. In some approaches, performing the user request may include processing payment for the media asset. In certain embodiments, the processing device transmits the media asset to a plurality of user devices to provide synchronized group access to the media asset. For example, companion users may view a media asset simultaneously on different devices to provide a social connection. In certain embodiments, the media asset is accessed through a social network application or website.

As shown, the outcome of the steps performed by the processing device in flow diagram 1200 differ from the outcome of the steps performed by the processing device in flow diagram 1100. In flow diagram 1200, the user requests are performed only after the time limit has been exceeded. The steps of diagram 1100 and 1200 may be used to accomplish different purposes and outcomes. For example the steps of diagram 1100 may be used to provide immediate access to the on-demand media asset immediately after the conditional minimum quantity of purchases is met. The steps of diagram 1200 may be suited for offering pre-sale of an on-demand media asset. For example, the media asset may be a movie that will become available on-demand at a future time, and the steps performed by the processing device in diagram 1200 may be used to encourage purchase of that asset before access is be granted.

In certain embodiments, the processing device generates an offer for a media asset that is conditioned on receiving requests to generate invitations for other users to participate in the conditional offer. For example, as discussed above, the processing device may provide display screens to allow users to make invitation selections directly from a user device as part of the request to purchase the media asset.

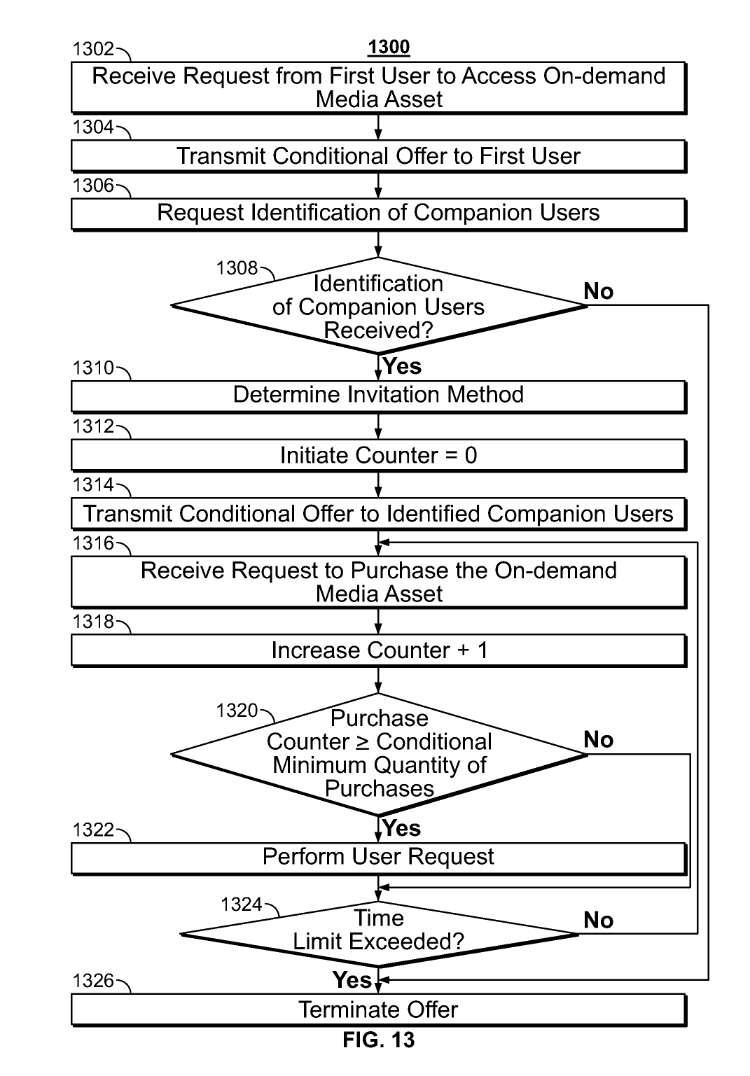

FIG. 13 illustrates a flow diagram for providing an offer conditioned on receiving identification of companion users in accordance with some embodiments of the present disclosure. The steps of diagram 1300 are performed by a processing device, such as control circuitry 304 of FIG. 3. In certain embodiments, remote server 415 performs the steps of flow diagram 1300. In certain embodiments, the steps of flow diagram 1400 are performed by a user device. Additionally or alternatively, the steps of flow diagram 1300 may be performed by the servers, modules, data stores, and devices 1000. Specifically, the steps of flow diagram 1300 may be performed by the conditional offer distribution module 1002 of system 1000.

At step 1302, the processing device receives a request from a first user to access an on-demand media asset. For example, step 1302 may be performed responsive to the user selecting on-demand listing 114, on-demand listing option 203, or advertisement 124. In certain approaches, step 1302 is performed responsive to the user selecting special offers option 504 of screen 500 or special offers option 604 of screen 600. In certain approaches, step 1302 is performed responsive to the processing device receiving a user request for a particular movie for on-demand viewing. The processing device may automatically generate a conditional offer and proceed to step 1304.

In certain embodiments, the request received at step 1302 may include a request for a user-defined conditional offer. For example, the request may include identification of a media asset, a requested conditional price, a requested minimum quantity of purchases required to receive the asset at the conditional price, a requested time period for purchasing the asset at the conditional price, or a combination thereof.

The processing device analyzes the request to generate a conditional group offer and determines a value factor. The value factor is an assessment of the request, which may incorporate transmission costs, estimated probability of receiving the minimum quantity of purchase requests, recent sales, recent user purchases, availability of the media asset, license agreements, profit margins, and other factors. If the value factor exceeds a predetermined threshold, the processing device proceeds to step 1304.

After a request is received to access an on-demand media asset, the processing device proceeds to step 1304 to transmit a conditional offer to the first user from whom the request was received to access an on-demand media asset. As discussed above, the conditional offer may be transmitted to the screen of a user device, such as television equipment 402, computer equipment 404, wireless user communications device 406 of FIG. 4, or user device 1010 of FIG. 10. In certain approaches, the conditional offer includes a promotional discount price for the media asset, which price is conditioned on a minimum quantity of purchase requests within a predetermined period of time. The conditional offer is further conditioned on the first user generating additional purchases of the media asset by inviting friends or other companion users. Accordingly, at step 1306, the processing device transmits a request for identification of companion users from the first user. For example, the first user may invite friends selecting an “Invite Friends” option. The processing device then provides companion user invitation options, such as those described in connection with FIG. 7 and FIG. 8. Step 1306 includes providing options for how the first user would like to invite the companion users. Step 1306 may include options such as an invitation to be delivered by user equipment, text message, email, or instant message. In certain approaches, step 1306 includes an option to enter a personal message for the invited companion user.

After requesting identification of companion users at step 1306, the processing device determines whether or not identification of companion users has been received at step 1308. If no companion users were identified by the first user, the processing device proceeds to step 1326 to terminate the offer. If the first user identifies companion users for the offer, process 1300 proceeds to step 1310. Step 1310 determines the invitation method based on the identification received from the first user. For example if a phone number was received, the invitation method may be a text message. Accordingly, other invitation methods may be used, including email messages and messages for delivery to a television or other screen.

The processing device of the user equipment or remote server performs step 1312 to initialize a counter to zero (0). The counter is used by the processing device to track the number of purchase requests for the media asset that is to be offered in a conditional group purchase offer. The counter may be implemented by control circuitry 304 of FIG. 3, and in certain approaches may be stored in a database such as offer data store 1006 of FIG. 10. At step 1314, the conditional group offer for an on-demand media asset is transmitted to one or more users. As discussed above, the conditional offer may be transmitted to the screen of a user device, such as television equipment 402, computer equipment 404, wireless user communications device 406 of FIG. 4, or user device 1010 of FIG. 10. The conditional offer may be transmitted by control circuitry 304 of a remote server through any communication means including but not limited to cable, Internet, telephone, text messaging, instant messaging, and email via communications network 414. The conditional offer may be transmitted to an individual user or, in certain embodiments, may be transmitted to a plurality of users. The conditional offer may include a promotional discount price for the media asset, which price is conditioned on receiving a minimum quantity of purchase requests within a predetermined period of time.

In certain approaches, the processing device which performs the steps of flow diagram 1300 may include a database to store the media asset, counter, purchase requests, and offer specifications, including the conditional price, the minimum quantity of purchases required to receive the asset at the conditional price, the time period for the conditional offer, or a combination thereof. The database may be stored, for example, in storage 308 of FIG. 3, memory of remote server 415 of FIG. 4, or offer data store 1006 of FIG. 10. The database may be modified and accessed by the control circuitry (e.g., control circuitry 304) of the remote server 415.

At step 1316 a request to purchase the on-demand media asset is received by the processing device. The request may be received, for example, at purchase request module 1012 of FIG. 10. The request to purchase is a commitment from a user to purchase the media asset at the conditional price if a minimum quantity of additional requests for the media asset are received by the processing device within a specified time period. The purchase request may include payment account information such as credit card, PayPal, bank account, or other account processing information with permission to access the payment account for processing the purchase when a sufficient quantity of purchases are requested. In certain implementations, the purchase request is a commitment to purchase the media asset even if the conditions of the conditional offer are not met. For example, a user may be willing to purchase the media asset at a standard price in order to access the media asset immediately, or to access the media asset even if the minimum quantity of purchases is not received. At step 1318, the processing device increases the counter by one (1), in response to receiving a request to purchase the on-demand media asset at step 1316. The processing device tracks the number of purchase requests for the media asset with the counter.

At step 1320, the processing device determines whether the quantity of purchase requests exceeds the conditional minimum quantity of purchases by comparing the purchase counter to the minimum quantity of purchases required for conditional offer. If the conditional minimum quantity of purchases has not been met, the processing device executes step 1324 to determine whether the time limit for the conditional offer has been exceeded. If the time limit for the offer has not been exceeded, the processing device proceeds to step 1316 to receive additional requests to purchase the on-demand media asset. As additional requests are received at step 1316, the processing device increases the counter by one (1) at step 1318 with each purchase request. These steps are performed by the processing device until either the purchase counter exceeds the conditional minimum quantity of purchases at step 1320 or the time limit for the conditional limit is exceeded at step 1324.

If, at step 1320, the purchase counter exceeds the conditional minimum quantity of purchases, the processing device executes step 1322 to perform a user request. The user request may include providing access to the media asset. In certain embodiments, for example, when the media asset is scheduled to be broadcast or transmitted at a specific time (e.g., a live event or pay-per-view program), the processing device performs the user request at step 1322 by broadcasting or otherwise transmitting the media asset at the specified time. In some approaches, performing the user request may include processing payment for the media asset. In certain embodiments, the processing device transmits the media asset to a plurality of user devices to provide synchronized group access to the media asset. For example, companion users may view a media asset simultaneously on different devices to provide a social connection. In certain embodiments, the media asset is accessed through a social network application or website. After performing the user request at step 1322, the processing device proceeds to step 1324 to determine if the time limit has been exceeded. If the time limit has not been exceeded, the processing device performs step 1316 and continues to receive requests to purchase the on-demand media asset. When the time limit has been exceeded, the processing device proceeds to step 1326 to terminate the offer. When the offer is terminated at step 1326, no additional purchase requests can be received for the transmitted conditional offer. If a sufficient quantity of purchase requests was received to meet the conditional minimum quantity of purchases as determined at step 1320, then the processing device will perform the purchase requests and provide access to the media asset to those users who made the purchase requests. However, if an insufficient quantity of purchase requests was received, those users who made the purchase requests will not be granted access to the on-demand media asset at the conditional price. The steps of process 1300 may be performed in alternative orders as well. In certain approaches, the user request is not performed until after the time limit for the conditional offer has been exceeded.

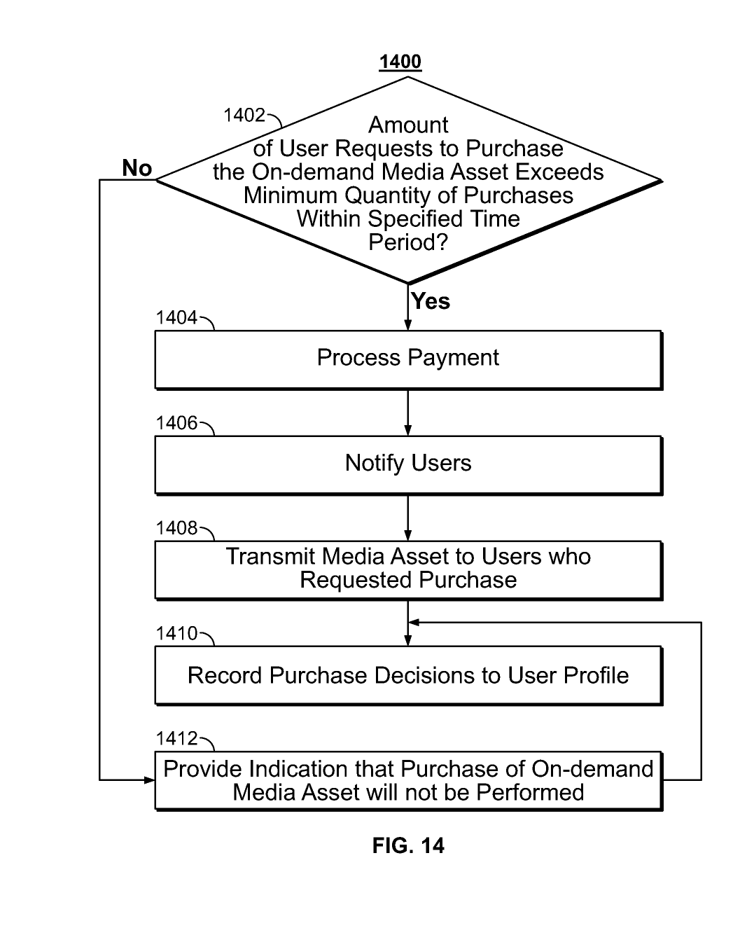

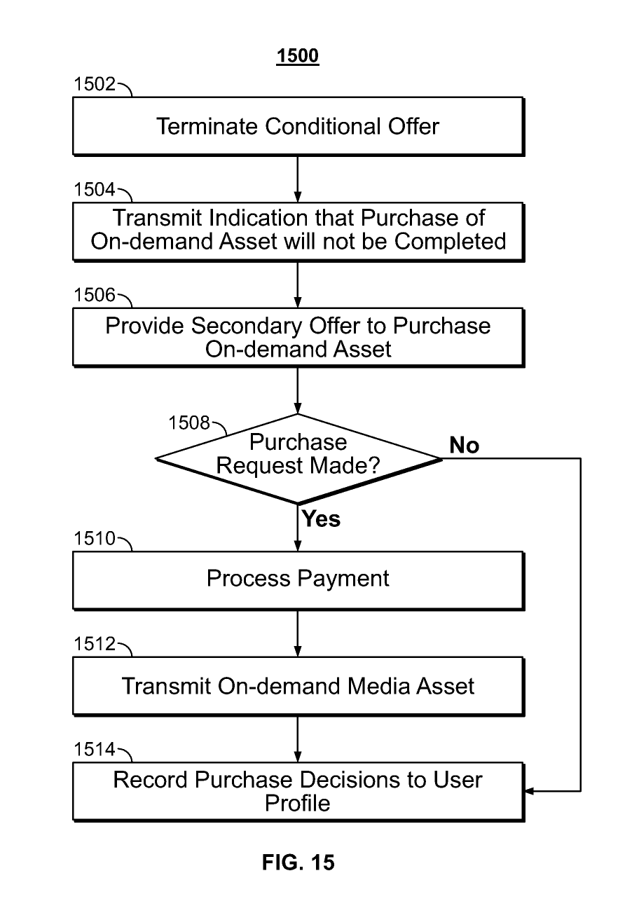

The processing device may perform one or more actions in response to the conditions of the offer being met or unmet. Exemplary actions are explained in further detail below in relation to FIG. 14 and FIG. 15.

FIG. 14 illustrates a flow diagram for processing a conditional offer in accordance with some embodiments of the present disclosure. The steps of flow diagram 1400 are performed by a processing device, such as control circuitry 304 of FIG. 3. In certain embodiments, remote server 415 performs the steps of flow diagram 1400. In certain embodiments, the steps of flow diagram 1400 are performed by a user device. Additionally or alternatively, the steps of flow diagram 1400 may be performed by the servers, modules, data stores, and devices 1000. Specifically, the steps of flow diagram 1400 may be performed by the conditional offer distribution module 1002 of system 1000.

In certain approaches, the processing device which performs the steps of flow diagram 1400 includes a database to store the media asset, counter, purchase requests, and offer specifications, including the conditional price, the minimum quantity of purchases required to receive the asset at the conditional price, the time period for the conditional offer, or a combination thereof. The database may be stored, for example, in storage 308 of FIG. 3, memory of remote server 415 of FIG. 4, or offer data store 1006 of FIG. 10. The database may be modified and accessed by the control circuitry (e.g., control circuitry 304) of the remote server 415.

At step 1402, the processing device determines whether the amount of user requests to purchase the on-demand media asset exceeds the minimum quantity of purchases within the specified time period defined by the conditional offer, for example, by accessing offer data store 1006. If the conditions are met at step 1402, the processing device performs step 1404 by processing payment for the media asset is processed. Process 1404 may include processing the payment through a credit card account, PayPal account, bank account, or other payment methods. In certain approaches, the payment for the media asset is billed directly to the service provider bill for the user. For example the payment may be charged to a monthly bill from a cable or Internet provider. In certain embodiments, the payment is processed by using credits, such as reward credits, in a user account.

Following step 1404, the processing device notifies the users who requested purchase of the on-demand media asset that the offer conditions were met. The notification may be provided by text on a screen, text message, email, or other electronic means. In certain embodiments, the users are notified by a statement on the bill from the cable or Internet service provider. The notification may include a message to the users that they may now access the requested media asset. The notification may also include identification of other users who also purchased the media asset. At step 1408, the processing device transmits the media asset to users who requested purchase of the media asset through the conditional offer. For example, the media asset may be transmitted to the users by media content distribution module 1016 of FIG. 10. The processing device may transmit the media asset via communications network 414 to a user device (e.g., television equipment 402, computer equipment 404, or wireless user communications device 406). In certain approaches the media asset is transmitted responsive to a user request to access the asset. For example, the user may select a download option from a user device or enter an access code allowing the user to view or receive the media asset. In certain approaches, for example, when the media asset is a live event, pay-per-view program, or other asset with a scheduled broadcast time, the processing device transmits the media asset at a specified time.

At step 1410, the processing device records purchase decisions to a user profile. A user profile may be in the form of a text file, Extensible Markup Language (XML) file, or other electronic format. In certain embodiments, the user profile is stored in storage 308 of FIG. 3. In certain embodiments, the user profile is stored in a remote server 415, media content source 416, or media guidance data source 418 of FIG. 4 or a different server connected to network 414 of FIG. 4. In certain embodiments, the user profile is stored in user information database 1004 of FIG. 10. At step 1410 the processing device may record the name of the media asset, the type of the media asset, the date purchased, and the purchase price. In certain embodiments, step 1410 includes recording the names or other identifiers of companion users who also purchased the media asset. Recording the purchase decisions at step 1410 to a user profile may enable improved recommendations for the users in the future. For example, the processing device may access the user profile to generate personalized offers by determining user preferences or identifying potential companion users who may be interested in accessing a media asset.

Returning to step 1402 of process 1400, if the number of user requests to purchase the on-demand media asset does not exceed the minimum quantity of purchases within the specified period of time, the processing device proceeds to step 1412. At step 1412, the processing device provides an indication to the users who requested purchase of the on-demand media asset that the purchase of the on-demand media asset will not be performed. The notification may be provided by text on a screen, text message, email, or other electronic means. Following step 1412, the processor executes step 1410 to record the purchase decisions to a user profile. In certain approaches, step 1410 includes recording that a user requested to purchase a media asset, but was unable to generate a sufficient number of additional purchase requests. The processing device may access the user profile to generate personalized offers by determining user preferences or identifying potential companion users who may be interested in accessing a media asset.

In certain embodiments, the processing device may perform additional actions after the conditional offer is terminated. FIG. 15 illustrates a flow diagram processing a terminated offer and providing a secondary offer. The steps of flow diagram 1500 are performed by a processing device, such as control circuitry 304 of FIG. 3. In certain embodiments, remote server 415 performs the steps of flow diagram 1500. In certain embodiments, the steps of flow diagram 1400 are performed by a user device. Additionally or alternatively, the steps of flow diagram 1500 may be performed by the servers, modules, data stores, and devices 1000. Specifically, the steps of flow diagram 1500 may be performed by the conditional offer distribution module 1002 of system 1000.

At step 1502 the conditional offer is terminated. Step 1502 may be similar to other steps in which the offer is terminated such as steps 1116, 1216 and 1326. When the offer is terminated at step 1502, no additional purchase requests can be received for the transmitted conditional offer. The steps of flow diagram 1500 may relate particularly to those users who requested a purchase of an on-demand media asset when the conditions of the offer were not met. In certain embodiments, the steps of flow diagram 1500 relate to those users who did not request purchase of the on-demand media asset. For example, a user may have declined the offer because the user was not interested in watching the offered media asset or because they had previously viewed the on-demand media asset.

At step 1504, the processing device transmits an indication that the purchase of the on-demand asset will not be completed. The indication may be provided as text on a screen, text message, email, or other electronic means. The processing device then provides a secondary offer to purchase an on-demand asset to a user at step 1506. The secondary offer provided at step 1506 to a user may be an offer to purchase the initially offered media asset at a price that is lower than the standard price, but higher than the previously offered group purchase price. In certain embodiments the secondary offer includes an offer to purchase a different on-demand media asset. For example, a user may have received an invitation to view an action movie, but declined the invitation because the user does not enjoy watching action movies. A secondary offer may be generated by the processing device by accessing the viewing preferences of the user, and then providing a secondary offer for a movie or on-demand media asset tailored to the user's preferences.

Following step 1506, the processing device executes step 1508 and determines whether or not a purchase request is made for the on-demand media asset offered through the secondary offer at step 1506. If no purchase request is made, for example, if the user declines the secondary offer, the processing device proceeds to step 1514 and records the purchase decision to a user profile. A user profile may be in the form of a text file, Extensible Markup Language (XML) file, or other electronic format. At step 1514 the processing device may record the name of the media asset, the type of the media asset, the date purchased, and the purchase price. Recording the purchase decisions at step 1514 to a user profile may enable improved recommendations for the user in the future. For example, the processing device may access the user profile to generate personalized offers by determining user preferences or identifying potential companion users who may be interested in accessing a media asset.

If a purchase request is made, the processing device proceeds to step 1510 and processes payment for the on-demand media asset. The processing device then transmits the on-demand media asset to the user at step 1512. For example, the media asset may be transmitted to the users by media content distribution module 1016 of FIG. 10. The media asset may be transmitted by the processing device via communications network 414 to a user device (e.g., television equipment 402, computer equipment 404, or wireless user communications device 406). In certain approaches the media asset is transmitted responsive to a user request to access the asset. For example, the user may select a download option from a user device or enter an access code allowing the user to view or receive the media asset. Step 1512 is followed by step 1514 to record the purchase decision of the user to a user profile.

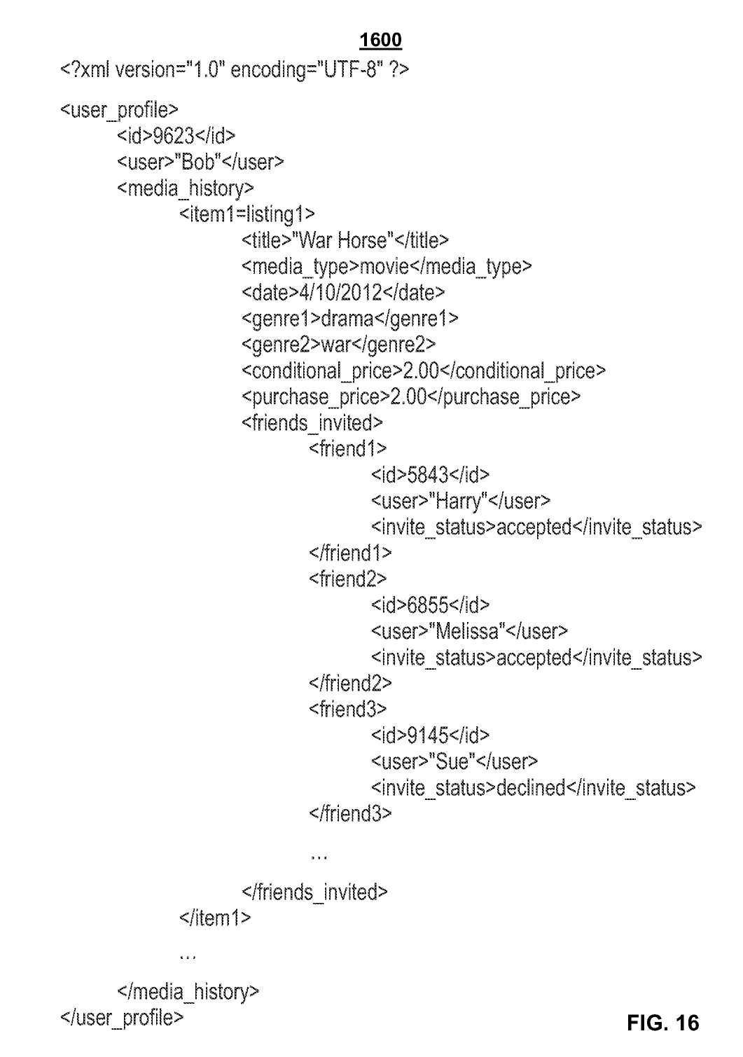

FIG. 16 shows an illustrative example of a user profile stored as a file 1600 in Extensible Markup Language (XML) in accordance with some embodiments of the invention. File 1600 may be an implementation of the media guidance source 418 of FIG. 4. While shown as XML, file 1600 may alternatively be in another suitable markup language (e.g., HTML5) or file format (e.g., Flash). File 1600 may be produced automatically in response to a conditional offer associated with a given user. File 1600 may be generated at a suitable time, implemented in a user information database (e.g., database 1004), stored in a storage and retrieved when requested (e.g., by control circuitry 304 of FIG. 3 or conditional offer distribution module 1002 of FIG. 10). In certain embodiments, the user profile is stored in storage 308. In certain embodiments, the user profile is stored in a remote server 415, media content source 416, or media guidance data source 418 of FIG. 4 or a different server connected to network 414 of FIG. 4. In certain embodiments, the user profile is stored in user information database 1004 of FIG. 10.

File 1600, as shown, may include tags and data specifying identification information (an ID number, a user entry) and media viewing or purchase history, including media content attributes (attribute names, genre, viewing dates, prices, and friends or companion user information). In certain approaches, file 1600 does not include all of the shown entries or may include additional entries. These entries may be automatically determined, accessed, modified, added, and updated during various points of the conditional offer process. In certain approaches, the user profile is accessed, for example, by control circuitry 304 of FIG. 3 or conditional offer distribution module 1002 of FIG. 10, to generate a conditional offer for the user. The conditional offer may be a unique offer tailored to the user preferences, and may include, for example, suggestions of friends to invite. For example, a profile associated with a first user may identify drama and action as favorite genres, or genres of movies in the user's viewing history. Control circuitry 304 of the user device or remote server may access the first user profile generate a conditional offer for a movie classified as drama, action, or both. Control circuitry 304 may additionally or alternatively access companion user profiles, find companion users who have also identified drama and action as favorite genres or have recently viewed movies in these categories, and generate a list of suggested companion users.

The ID number may be used internally by the system to identify and/or track the user profile. For example, a user profile may include ID numbers for each conditional offer associated with (e.g., offered to or purchased by) the user. The user entry may specify the name of the user, which may be used to link back to the records in the database. For example, the user entry may be used to locate the appropriate records in the database.

File 1600 includes a media history. As shown, file 1600 specifies the title, media type, date, genre, conditional price of the movie, and actual purchase price of the movie. The entries for the movie specifications may be automatically generated when the user is presented a conditional offer. Certain fields, such as the purchase price and the list of friends invited, may be generated responsive to interactions with the user and companion users. For example, the purchase price is dependent on the conditions of the offer being met (e.g., a sufficient number of purchases within a specified time period). In the depicted case, the purchase price is the same as the conditional price, indicating the conditions of the offer were met. However, a user may decide to purchase the media asset even if the conditions are not met, in which case the conditional price may be different than the actual purchase price. In certain embodiments, control circuitry 304 may access a purchase history within a user profile associated with a user to generate a discounted price in a conditional offer. For example, a user may typically purchase on-demand media content for $3 or less. Control circuitry 304 may then generate a conditional offer for a media asset with a price of $3 or less.

In certain approaches, the media history includes a list of friends whom the user invited to participate in the conditional offer. The listing of friends invited may include data specifying identification information (an ID number, a user entry). The ID number may be used internally by the system to identify and/or track the profiles of the friends. The user entry may specify the name of the friend user, which may be used to link back to the records in the database. For example, the user entry may be used to locate the appropriate records in the database. The listing of friends may also include an indication (e.g., “invite status”) of whether the friend accepted or declined the invitation to participate in the conditional offer. In certain embodiments, the list of friends is accessed (e.g., by control circuitry 304 of FIG. 3 or conditional offer distribution module 1002 of FIG. 10) to generate a conditional offer with suggestions of friends to invite.

It will be apparent to those of ordinary skill in the art that methods, techniques, and processes involved in the present disclosure may be embodied in a computer program product that includes a non-transitory computer usable and/or readable medium. For example, such a non-transitory computer readable medium may consist of a read-only memory device, such as a CD-ROM disk or conventional ROM devices, or a random access memory, such as a hard drive device or a computer diskette, having a computer readable program code stored thereon.

It will be appreciated that while the discussion of media content has focused on on-demand media assets, the principles of providing conditional group purchase offers to access a media asset can be applied to other types of media content such as pay-per-view programs, Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. For example, the conditional offer may be for a pay-per-view program or live event. The processing device, such as control circuitry 304, transmits the media asset at a specified time.

Although present disclosure has been described primarily with regard to a conditional group purchase offer to access a media asset at a reduced price, the conditional offer may additionally or alternatively include other incentives, such as enhanced access rights or privileges to the media asset. For example, when the minimum quantity of purchase requests is met, the control circuitry 304 of the remote server may provide access to the media asset on multiple devices, extend the access period (e.g., standard access may be for 1 day and extended access may be for 1 week), provide a high definition version of a media asset instead of a standard definition version, provide credits for receiving additional media assets, or provide additional or exclusive media assets (e.g., “bonus content”).

It is to be understood that while certain forms of the present disclosure have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for delivering an on-demand media asset to a plurality of users, comprising:
transmitting, with a processing device over a network, a conditional offer for an on-demand media asset, wherein the conditional offer is conditioned on a minimum quantity of purchases being performed within a specified time period;
receiving, at the processing device, a plurality of user requests to purchase the on-demand media asset;
determining, at the processing device, whether an amount of user requests in the plurality of user requests exceeds the minimum quantity of purchases within the specified time period; and
performing an action, at the processing device, corresponding to the conditional offer in response to the determining.

2. The method of claim 1, wherein the conditional offer is for an access privilege to the media asset, wherein the access privilege is at least one of access to the media asset at a discounted price, access to the media asset on a plurality of devices, access to the media asset for an extended time period, access to a high definition version of the media asset, and access to a second media asset.

3. The method of claim 1, wherein performing the action comprises enabling access, with the processing device over the network, to the on-demand media asset to users from whom the plurality of requests were received, in response to determining that the amount exceeds the minimum quantity of purchases within the specified time period.

4. The method of claim 3, wherein enabling access to the on-demand media asset comprises synchronizing access to the on-demand media asset at a plurality of user devices.

5. The method of claim 1, wherein performing the action comprises processing a payment for each of the plurality of requests to complete the purchase for the on-demand media asset, in response to determining that the amount exceeds the minimum quantity of purchases within the specified time period.

6. The method of claim 1, wherein performing the action comprises processing a payment for each of the plurality of requests to complete the purchase for the on-demand media asset at a standard price, in response to determining that the amount does not exceed the minimum quantity of purchases within the specified time period.

7. The method of claim 1, further comprising:
accessing, with the processing device over the network, a user profile associated with a first user;
analyzing, with the processing device, the user profile; and
generating, with the processing device, the conditional offer, based on the analyzing.

8. The method of claim 1, further comprising:
receiving, from a first user, at the processing device over the network, identification of a plurality of companion users; and
transmitting the conditional offer to the plurality of companion users identified by the first user.

9. The method of claim 1, further comprising:
accessing, with the processing device, a plurality of user profiles associated with a plurality of companion users;
analyzing, with the processing device, the plurality of user profiles;
generating, with the processing device, a list of companion users, based on the analyzing; and
transmitting, with the processing device, the list of companion users to a user device associated with a first user.

10. The method of claim 1, further comprising:
receiving, from a first user, at the processing device over the network, a selection for an on-demand media asset;
receiving, from the first user, at the processing device over the network, a request to generate the conditional offer for the on-demand media asset; and
generating, at the processing device, the conditional offer for the on-demand media asset.

11. A system for delivering an on-demand media asset to a plurality of users, the system comprising:
a database configured to store a set of attributes for a conditional offer and purchase requests for the conditional offer, wherein the conditional offer is conditioned on a minimum quantity of purchases being performed within a specified time period; and
a processor configured to:
transmit the conditional offer, over a network, for an on-demand media asset;
receive a plurality of user requests to purchase the on-demand media asset;
determine whether an amount of user requests in the plurality of user requests exceeds the minimum quantity of purchases within the specified time period; and
perform an action corresponding to the conditional offer in response to the determining.

12. The system of claim 11, wherein the conditional offer is for an access privilege to the media asset, wherein the access privilege is at least one of access to the media asset at a discounted price, access to the media asset on a plurality of devices, access to the media asset for an extended time period, access to a high definition version of the media asset, and access to a second media asset.

13. The system of claim 11, wherein the processor is configured to perform the action by enabling access, over the network, to the on-demand media asset to users from whom the plurality of requests were received, in response to determining that the amount exceeds the minimum quantity of purchases within the specified time period.

14. The system of claim 13, wherein the processor is configured to enable access to the on-demand media asset by synchronizing access to the on-demand media asset at a plurality of user devices.

15. The system of claim 11, the processor is configured to perform the action by processing a payment for each of the plurality of requests to complete the purchase for the on-demand media asset, in response to determining that the amount exceeds the minimum quantity of purchases within the specified time period.

16. The system of claim 11, the processor is configured to perform the action by processing a payment for each of the plurality of requests to complete the purchase for the on-demand media asset at a standard price, in response to determining that the amount does not exceed the minimum quantity of purchases within the specified time period.

17. The system of claim 11, wherein the processor is configured to:
access, over a network, a user profile associated with a first user;
analyze the user profile; and
generate the conditional offer, based on the analyzing.

18. The system of claim 11, wherein the processor is configured to:
receive, from a first user over a network, identification of a plurality of companion users; and
transmit the conditional offer to the plurality of companion users identified by the first user.

19. The system of claim 11, wherein the processor is configured to:
access a plurality of user profiles associated with a plurality of companion users;
analyze the plurality of user profiles;
generate a list of companion users, based on the analyzing; and
transmit the list of companion users to a user device associated with a first user.

20. The system of claim 11, wherein the processor is configured to:
receive, from a first user over the network, a selection for an on-demand media asset;
receive, from a first user over the network, a request to generate a conditional offer for the on-demand media asset; and
generate a conditional offer for the on-demand media asset.

21-30. (canceled)
